(19) United States
(12) Patent Application Publication
(10) Pub. No.: US 2013/0083846 A1
(43) Pub. Date: Apr. 4, 2013

(54) IMAGE ENCODING APPARATUS, IMAGE ENCODING METHOD, IMAGE ENCODING PROGRAM, IMAGE DECODING APPARATUS, IMAGE DECODING METHOD, AND IMAGE DECODING PROGRAM

(71) Applicant: Toru KUMAKURA, Yokohama-shi (JP)

(72) Inventor: Toru KUMAKURA, Yokohama-shi (JP)

(73) Assignee: JVC KENWOOD CORPORATION, Yokohama-shi (JP)

(21) Appl. No.: 13/615,150

(22) Filed: Sep. 13, 2012

(30) Foreign Application Priority Data
Sep. 29, 2011 (JP) 2011-215272
Sep. 29, 2011 (JP) 2011-215273

(51) Int. Cl. H04N 7/32

(52) U.S. Cl. 375/240.08; 375/E07.243

(57) ABSTRACT

A luminance intra prediction mode encoding unit encodes a luminance component intra frame prediction mode for an encoding target block. A color difference intra prediction mode encoding unit encodes color difference prediction mode determination information for identifying a color difference component intra frame prediction mode for the encoding target block, referring to the luminance component intra frame prediction mode for the encoding target block, and then selects a vertical mode or a horizontal mode, each configured as a color difference component intra frame prediction mode, such that the selected mode has a smaller or otherwise greater angle between itself and the luminance component intra frame prediction mode for the encoding target block, and encodes color difference prediction mode determination information which indicates a vertical/horizontal mode in which the selected mode is employed as the color difference component intra frame prediction mode for the encoding target block.

### BACKGROUND OF THE INVENTION

1. Field of the Invention

The present invention relates to an image encoding and decoding technique, and particularly to an intra frame encoding and decoding technique.

2. Description of the Related Art

MPEG-4 AVC, which is an international moving image encoding standard, employs a so-called intra prediction method as an intra frame encoding method in which image processing is completed within a frame. With such an intra prediction method, an encoded sample value adjacent to a block to be processed is duplicated in a specified prediction direction, thereby generating a predicted image for each block to be processed. In MPEG-4 AVC, nine kinds of prediction directions are defined as shown in FIGS. 1A and 1B. By transmitting a mode number of the intra prediction mode which indicates the prediction direction for each block, such an arrangement allows a suitable prediction direction to be specified.

By increasing the number of prediction directions thus defined, such an arrangement provides improved predicted image quality. The reference numeral 201 in FIG. 2A denotes an example definition of 17 kinds of prediction directions. The reference numeral 202 in FIG. 2B denotes an example definition of 34 kinds of prediction directions. However, an increase in the number of defined prediction directions leads to an increase in the amount of transmitted information with respect to the intra prediction mode. As the number of defined prediction directions becomes larger, the ratio of the code quantity involved in the intra prediction mode becomes larger with respect to the sum total of the generated code quantity. Thus, there is an increased demand for a code transmission method having high efficiency.

Patent document 1 discloses a technique in which the sum total of the intra frame prediction modes to be transmitted is reduced, thereby reducing the code quantity involved in the intra frame prediction mode. Specifically, with the method disclosed in Patent document 1, intra frame prediction mode scanning is performed for multiple blocks in units of integrated blocks, each of which consists of a predetermined number of blocks. When the same intra frame prediction mode is detected for all the blocks in a given integrated block, a single intra frame prediction mode is transmitted for the integrated block unit, thereby reducing the number of intra frame prediction modes to be transmitted.

### RELATED ART DOCUMENTS

### Patent Documents

[Patent document 1]
Japanese Patent Application Laid Open No. 2009-246975

With MPEG-4 AVC, an intra prediction mode is defined for both luminance and color difference. The luminance intra prediction mode and the color difference intra prediction mode are defined independently and are not correlated to each other. Thus, such intra prediction mode encoding has redundancy, leading to a reduction in the encoding efficiency.

### SUMMARY OF THE INVENTION

The present invention has been made in view of such a situation. Accordingly, it is a general purpose of the present invention to provide an image encoding/decoding technique which is capable of reducing the code quantity involved in the intra prediction mode, thereby providing further improved encoding efficiency.

In order to solve the aforementioned problem, an image encoding apparatus according to an embodiment of the present invention relates to an image encoding apparatus configured to encode an image signal in units of blocks using an intra frame prediction mode selected from among multiple intra frame prediction modes, and to encode information to be used to identify the intra frame prediction mode thus selected. The image encoding apparatus comprises: a luminance component intra frame prediction mode encoding unit (601) configured to encode an intra frame prediction mode for a luminance component of an encoding target block; a luminance component intra frame prediction mode storage unit (602) configured to store the intra frame prediction mode for the luminance component of the encoding target block; and a color difference component intra frame prediction mode encoding unit (603) configured to encode color difference prediction mode determination information used to identify the intra frame prediction mode for a color difference component of the encoding target block with reference to the intra frame prediction mode for the luminance component of the encoding target block stored in the luminance component intra frame prediction mode storage unit. When the intra frame prediction mode for the color difference component of the encoding target block is the same as the intra frame prediction mode for the luminance component of the encoding target block, the color difference component intra frame prediction mode encoding unit (603) is configured to encode the color difference prediction mode determination information which represents an inheritance mode in which the intra frame prediction mode for the luminance component is used as it is as the intra frame prediction mode for the color difference component of the encoding target block. The color difference component intra frame prediction mode encoding unit (603) is configured to encode the color difference prediction mode determination information which represents a vertical/horizontal mode in which a mode having a smaller angle or otherwise a greater angle between itself and the intra frame prediction mode for the luminance component of the encoding target block is selected from among a vertical mode and a horizontal mode, which are each configured as an intra frame prediction mode for the color difference component, as an intra frame prediction mode for the color difference component of the encoding target block.

Another embodiment of the present invention also relates to an image encoding apparatus. The image encoding apparatus is configured to encode an image signal in units of blocks using an intra frame prediction mode selected from among multiple intra frame prediction modes, and to encode information to be used to identify the intra frame prediction mode thus selected. The image encoding apparatus comprises: a luminance component intra frame prediction mode encoding unit (601) configured to encode an intra frame prediction mode for a luminance component of an encoding target block; a luminance component intra frame prediction mode storage unit (602) configured to store the intra frame prediction mode for the luminance component of the encoding target block; and a color difference component intra frame prediction mode encoding unit (603) configured to encode color difference prediction mode determination information used to identify the intra frame prediction mode for a color difference component of the encoding target block with reference to the intra frame prediction mode for the luminance component of the encoding target block stored in the luminance component intra frame prediction mode storage unit. When the intra frame prediction mode for the color difference component of the encoding target block is the same as the intra frame prediction mode for the luminance component of the encoding target block, the color difference component intra frame prediction mode encoding unit (603) is configured to encode the color difference prediction mode determination information which represents an inheritance mode in which the intra frame prediction mode for the luminance component is used as it is as the intra frame prediction mode for the color difference component of the encoding target block. Furthermore, the color difference component intra frame prediction mode encoding unit (603) is configured to encode the color difference prediction mode determination information which represents an adjacent mode in which a mode adjacent to the intra frame prediction mode for the luminance component of the encoding target block is selected from among multiple intra frame prediction modes for the color difference component as an intra frame prediction mode for the color difference component of the encoding target block.

Yet another embodiment of the present invention relates to an image encoding method for encoding an image signal in units of blocks using an intra frame prediction mode selected from among multiple intra frame prediction modes, and for encoding information to be used to identify the intra frame prediction mode thus selected. The image encoding method comprises: luminance component intra frame prediction mode encoding in which an intra frame prediction mode for a luminance component of an encoding target block is encoded; and color difference component intra frame prediction mode encoding in which color difference component intra frame prediction mode determination information used to identify the intra frame prediction mode for a color difference component of the encoding target block is encoded with reference to the intra frame prediction mode for the luminance component of the encoding target block stored in memory configured to store the intra frame prediction mode for the luminance component of the encoding target block. In the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded. Furthermore, in the aforementioned color difference component intra frame prediction mode encoding, the color difference prediction mode determination information which represents a vertical/horizontal mode in which a mode having a smaller angle or otherwise a greater angle between itself and the intra frame prediction mode for the luminance component of the encoding target block is selected from among a vertical mode and a horizontal mode, which are each configured as an intra frame prediction mode for the color difference component, as an intra frame prediction mode for the color difference component of the encoding target block, is encoded.

Yet another embodiment of the present invention also relates to an image encoding method for encoding an image signal in units of blocks using an intra frame prediction mode selected from among multiple intra frame prediction modes, and for encoding information to be used to identify the intra frame prediction mode thus selected. The image encoding method comprises: luminance component intra frame prediction mode encoding in which an intra frame prediction mode for a luminance component of an encoding target block is encoded; and color difference component intra frame prediction mode encoding in which color difference component intra frame prediction mode determination information used to identify the intra frame prediction mode for a color difference component of the encoding target block is encoded with reference to the intra frame prediction mode for the luminance component of the encoding target block stored in memory configured to store the intra frame prediction mode for the luminance component of the encoding target block. In the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded. Furthermore, in the aforementioned color difference component intra frame prediction mode encoding, the color difference prediction mode determination information which represents an adjacent mode in which a mode adjacent to the intra frame prediction mode for the luminance component of the encoding target block is selected from among multiple intra frame prediction modes for the color difference component as an intra frame prediction mode for the color difference component of the encoding target block, is encoded.

An embodiment of the present invention relates to an image decoding apparatus. The image decoding apparatus is configured to decode an encoded stream into information to be used to identify an intra frame prediction mode in units of blocks, and to decode an image signal using the decoded information for identifying the intra frame prediction mode. The image decoding apparatus comprises: a luminance component intra frame prediction mode decoding unit (901) configured to decode an intra frame prediction mode for a luminance component of a decoding target block; a luminance component intra frame prediction mode storage unit (902) configured to store the intra frame prediction mode for the luminance component of the decoding target block; and a color difference component intra frame prediction mode decoding unit (903) configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in the luminance component intra frame prediction mode storage unit. When the color difference prediction mode determination information thus decoded indicates an inheritance mode in which the intra frame prediction mode for the luminance component of the decoding target block is to be used as it is as the intra frame prediction mode for the color difference component of the decoding target block, the color difference component intra frame prediction mode decoding unit (903) is configured to set the intra frame prediction mode for the color difference component of the decoding target block to the same value as that of the intra frame prediction mode for the luminance component of the decoding target block. When the color difference prediction mode determination information thus decoded indicates a vertical/horizontal mode in which either a vertical mode or a horizontal mode, which are each configured as an intra frame prediction mode for the color difference component, is selectively used, the color difference component intra frame prediction mode decoding unit (903) is configured to set the color difference component intra frame prediction mode for the decoding target block to a mode selected from among the vertical mode and the horizontal mode, which are each configured as a color difference component intra frame prediction mode, such that it has a smaller or otherwise greater angle between itself and the intra frame prediction mode for the luminance component of the decoding target block.

Another embodiment of the present invention also relates to an image decoding apparatus. The image decoding apparatus is configured to decode an encoded stream into information to be used to identify an intra frame prediction mode in units of blocks, and to decode an image signal using the decoded information for identifying the intra frame prediction mode. The image decoding apparatus comprises: a luminance component intra frame prediction mode decoding unit (901) configured to decode an intra frame prediction mode for a luminance component of a decoding target block; a luminance component intra frame prediction mode storage unit (902) configured to store the intra frame prediction mode for the luminance component of the decoding target block; and a color difference component intra frame prediction mode decoding unit (903) configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in the luminance component intra frame prediction mode storage unit. When the color difference prediction mode determination information thus decoded indicates an inheritance mode in which the intra frame prediction mode for the luminance component of the decoding target block is to be used as it is as the intra frame prediction mode for the color difference component of the decoding target block, the color difference component intra frame prediction mode decoding unit (903) is configured to set the intra frame prediction mode for the color difference component of the decoding target block to the same value as that of the intra frame prediction mode for the luminance component of the decoding target block. When the color difference prediction mode determination information thus decoded indicates an adjacent mode in which a mode adjacent to the intra frame prediction mode for the luminance component of the decoding target block is used, the color difference component intra frame prediction mode decoding unit (903) is configured to set the intra frame prediction mode for the color difference component of the decoding target block to a mode adjacent to the intra frame prediction mode for the luminance component of the decoding target block selected from among multiple intra frame prediction modes for the color difference component.

Yet another embodiment of the present invention relates to an image decoding method for decoding an encoded stream into information to be used to identify an intra frame prediction mode in units of blocks, and for decoding an image signal using the decoded information for identifying the intra frame prediction mode. The image decoding method comprises: luminance component intra frame prediction mode decoding in which an intra frame prediction mode for a luminance component of a decoding target block is decoded; and color difference component intra frame prediction mode decoding in which color difference prediction mode determination information to be used to identify an intra frame prediction mode for a color difference component of the decoding target block is decoded, and the intra frame prediction mode for the color difference component of the decoding target block is obtained based upon the color difference prediction mode determination information with reference to the intra frame prediction mode for the luminance component of the decoding target block stored in memory configured to store the intra frame prediction mode for the luminance component of the decoding target block. In the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block. Furthermore, in the color difference component intra frame prediction mode decoding, when the color difference prediction mode determination information thus decoded indicates a vertical/horizontal mode in which either a vertical mode or a horizontal mode, which are each configured as an intra frame prediction mode for the color difference component, is selectively used, the color difference component intra frame prediction mode for the decoding target block is set to a mode selected from among the vertical mode and the horizontal mode, which are each configured as a color difference component intra frame prediction mode, such that it has a smaller or otherwise greater angle between itself and the intra frame prediction mode for the luminance component of the decoding target block.

Yet another embodiment of the present invention also relates to an image decoding method for decoding an encoded stream into information to be used to identify an intra frame prediction mode in units of blocks, and for decoding an image signal using the decoded information for identifying the intra frame prediction mode. The image decoding method comprises: luminance component intra frame prediction mode decoding in which an intra frame prediction mode for a luminance component of a decoding target block is decoded; and color difference component intra frame prediction mode decoding in which color difference prediction mode determination information to be used to identify an intra frame prediction mode for a color difference component of the decoding target block is decoded, and the intra frame prediction mode for the color difference component of the decoding target block is obtained based upon the color difference prediction mode determination information with reference to the intra frame prediction mode for the luminance component of the decoding target block stored in memory configured to store the intra frame prediction mode for the luminance component of the decoding target block. In the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block. Furthermore, in the color difference component intra frame prediction mode decoding, when the color difference prediction mode determination information thus decoded indicates an adjacent mode in which a mode adjacent to the intra frame prediction mode for the luminance component of the decoding target block is used, the intra frame prediction mode for the color difference component of the decoding target block is set to a mode adjacent to the intra frame prediction mode for the luminance component of the decoding target block selected from among multiple intra frame prediction modes for the color difference component.

It should be noted that any combination of the aforementioned components or any manifestation thereof may be mutually substituted between a method, apparatus, system, recording medium, computer program, and so forth, which are effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram for describing prediction directions of 9 patterns of intra prediction modes;

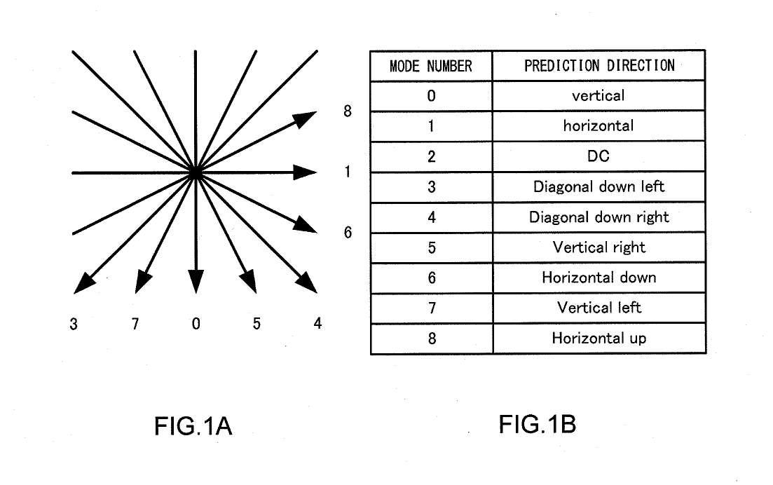

FIG. 2 is a diagram for describing prediction directions of 18 patterns of intra prediction modes and prediction directions of 35 patterns of intra prediction modes;

FIG. 3 is a schematic diagram for describing an image block configuration and a reference block;

FIG. 4 shows a reference table for calculating a horizontal/vertical mode and an adjacent mode;

FIG. 5 is a block diagram which shows a configuration of an image encoding method configured to execute an intra prediction mode encoding apparatus according to an embodiment;

FIG. 6 is a block diagram which shows a detailed configuration of the intra prediction mode encoding unit shown in FIG. 5 according to a first embodiment;

FIG. 7 is a flowchart for describing an intra prediction mode encoding procedure performed by the intra prediction mode encoding unit shown in FIG. 6;

FIG. 8 is a block diagram which shows a configuration of an image decoding apparatus configured to execute a decoding method for an intra prediction mode according to the embodiment;

FIG. 9 is a block diagram which shows a detailed configuration of the intra prediction mode decoding unit shown in FIG. 8 according to the first embodiment;

FIG. 10 is a flowchart for describing an intra prediction mode decoding procedure performed by the intra prediction mode decoding unit shown in FIG. 9;

FIG. 11 is a flowchart for describing a procedure for encoding the color difference intra prediction mode according to the first embodiment;

FIG. 12 is a flowchart for describing a procedure for decoding the color difference intra prediction mode according to the first embodiment;

FIG. 13 is a mapping table which shows the relation between the color difference prediction mode determination information, the luminance intra prediction mode, and the color difference intra prediction mode, according to the first embodiment;

FIG. 14 is a flowchart for describing a procedure for encoding the color difference intra prediction mode according to the second embodiment;

FIG. 15 is a flowchart which shows a procedure for decoding the color difference intra prediction mode according to a second embodiment;

FIG. 16 is a mapping table which shows the relation between the color difference prediction mode determination information, the luminance intra prediction mode, and the color difference intra prediction mode, according to the second embodiment;

FIG. 17 is a flowchart for describing a procedure for encoding the color difference intra prediction mode according to a third embodiment;

FIG. 18 is a flowchart for describing a procedure for decoding the color difference intra prediction mode according to the third embodiment;

FIG. 19 is a mapping table which shows the relation between the color difference prediction mode determination information, the luminance intra prediction mode, and the color difference intra prediction mode, according to the third embodiment;

FIG. 20 is a flowchart for describing a procedure for encoding the color difference intra prediction mode according to a fourth embodiment;

FIG. 21 is a flowchart for describing a procedure for decoding the color difference intra prediction mode according to the fourth embodiment; and

FIG. 22 is a mapping table which shows the relation between the color difference prediction mode determination information, the luminance intra prediction mode, and the color difference intra prediction mode, according to the fourth embodiment.

### DETAILED DESCRIPTION OF THE INVENTION

The invention will now be described by reference to the preferred embodiments. This does not intend to limit the scope of the present invention, but to exemplify the invention.

In the following description, a “block to be processed” in the encoding processing performed by an image encoding apparatus represents a block to be encoded. On the other hand, a “block to be processed” in the decoding processing performed by an image decoding apparatus represents a block to be decoded. The term “processed block” in the encoding processing performed by an image encoding apparatus represents an encoded block. On the other hand, “processed block” in the decoding processing performed by an image decoding apparatus represents a decoded block. In the following description, these terms are used as described above unless otherwise noted.

### [Encoding Apparatus]

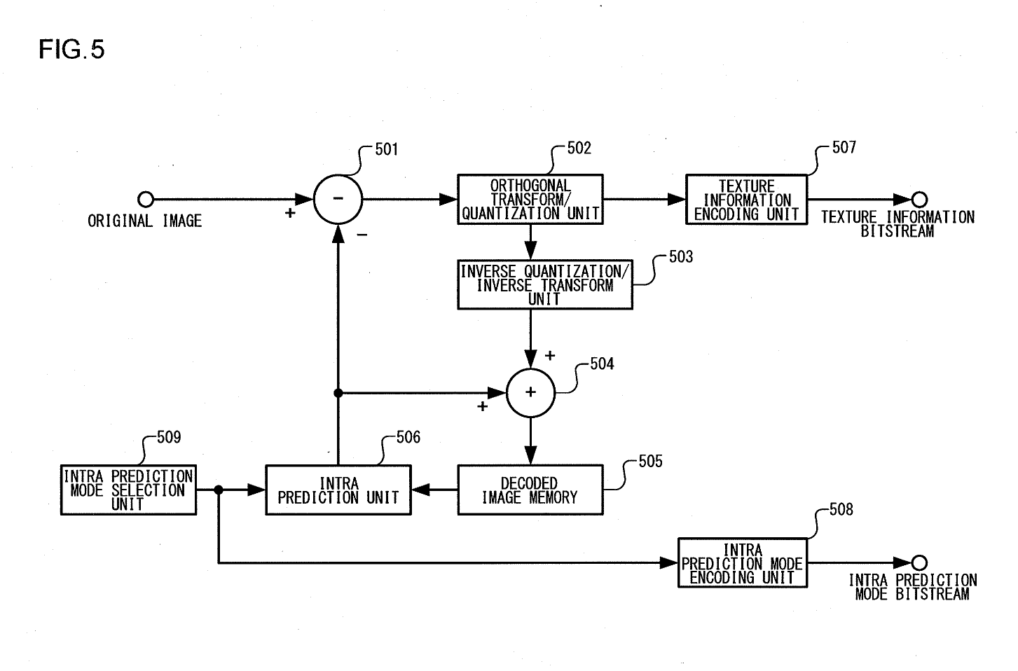

Description will be made with reference to drawings regarding a preferred image encoding apparatus configured to realize the present invention. FIG. 5 is a block diagram which shows a configuration of an image encoding apparatus according to an embodiment. The image encoding apparatus according to the embodiment includes a subtractor unit 501, an orthogonal transform/quantization unit 502, an inverse quantization/inverse transform unit 503, an adder unit 504, decoded image memory 505, an intra prediction unit 506, a texture information encoding unit 507, an intra prediction mode encoding unit 508, and an intra prediction mode selection unit 509. The embodiment of the present invention is configured directing attention to intra frame prediction. Accordingly, the components relating to inter-frame prediction are not shown, and description thereof will be omitted.

The intra prediction mode selection unit 509 is configured to select the optimum intra prediction mode for each block in the image, and to supply the intra prediction mode thus selected to the intra prediction unit 506 and the intra prediction mode encoding unit 508.

The intra prediction mode encoding unit 508 is configured to perform variable-length encoding of the intra prediction mode thus input, and to output an intra prediction mode bit stream. Detailed description will be made later regarding the configuration and operation of the intra prediction mode encoding unit 508.

The intra prediction unit 506 is configured to generate an intra prediction image using the intra prediction mode thus input and the decoded image of an adjacent block stored in the decoded image memory 505, and to supply the intra prediction image thus generated to the subtractor unit 501.

The subtractor unit 501 is configured to generate a differential image by subtracting the intra prediction image from the original image to be encoded, and to supply the differential signal thus generated to the orthogonal transform/quantization unit 502.

The orthogonal transform/quantization unit 502 is configured to perform orthogonal transform/quantization of the differential image so as to generate texture information, and to supply the texture information thus generated to the inverse quantization/inverse transform unit 503 and the texture information encoding unit 507.

The texture information encoding unit 507 is configured to perform entropy encoding of the texture information so as to output a texture information bit stream.

The inverse quantization/inverse transform unit 503 is configured to perform inverse quantization and inverse orthogonal transform of the texture information received from the orthogonal transform/quantization unit 502 so as to generate a decoded differential signal, and to supply the decoded differential signal thus generated to the adder unit 504.

The adder unit 504 is configured to perform addition of the intra prediction image and the decoded differential image so as to generate a decoded image, and to store the decoded image thus generated in the decoded image memory 505.

### [Decoding Apparatus]

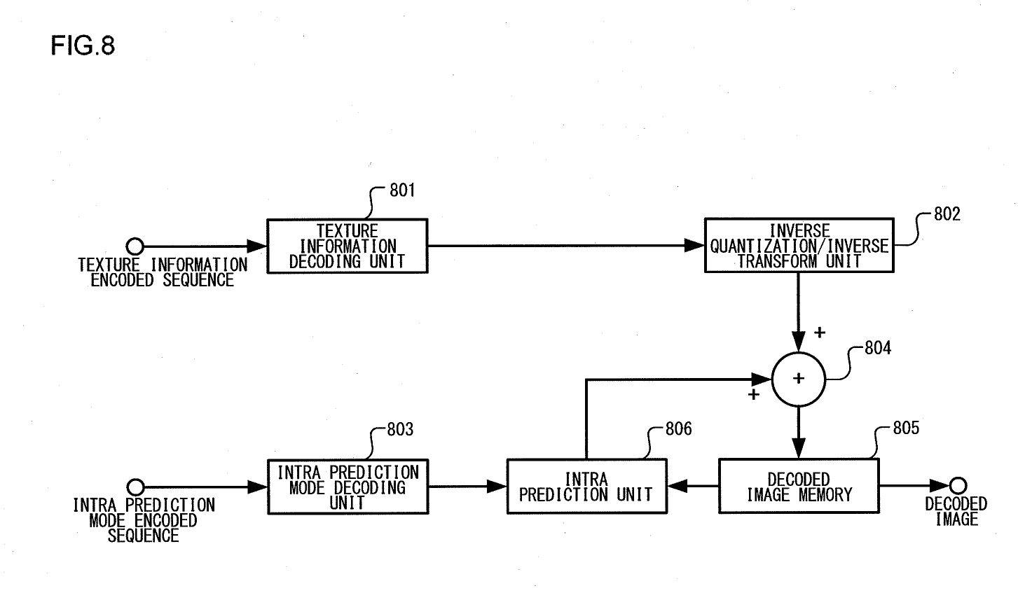

Description will be made with reference to drawings regarding a preferred image decoding apparatus configured to realize the present invention. FIG. 8 is a block diagram which shows a configuration of an image decoding apparatus according to an embodiment. The image decoding apparatus according to the embodiment includes a texture information decoding unit 801, an inverse quantization/inverse transform unit 802, an intra prediction mode decoding unit 803, an adder unit 804, decoded image memory 805, and an intra prediction unit 806. The embodiment of the present invention is configured directing attention to the intra frame prediction. Accordingly, the components relating to inter-frame prediction are not shown, and description thereof will be omitted.

The decoding operation of the image decoding apparatus shown in FIG. 8 corresponds to the decoding function implemented in the image encoding apparatus shown in FIG. 5. Thus, the respective components shown in FIG. 8, i.e., the inverse quantization/inverse transform unit 802, the adder unit 804, the decoded image memory 805, and the intra prediction unit 806, respectively correspond to the functions of the respective components of the image encoding apparatus shown in FIG. 5, i.e., the inverse quantization/inverse transform unit 503, the adder unit 504, the decoded image memory 505, and the intra prediction unit 506.

The intra prediction mode decoding unit 803 is configured to perform entropy decoding of the input intra prediction mode bit stream so as to generate an intra prediction mode, and to supply the intra prediction mode thus generated to the intra prediction unit 806. Detailed description will be made later regarding the configuration and operation of the intra prediction mode decoding unit 803.

The intra prediction unit 806 is configured to generate an intra predicted image using the intra prediction mode thus input and the decoded image of an adjacent block stored in the decoded image memory 805, and to supply the intra predicted image thus generated to the adder unit 804.

The texture information decoding unit 801 is configured to perform entropy decoding of the texture information so as to generate the texture information. The texture information thus generated is supplied to the inverse quantization/inverse transform unit 802.

The inverse quantization/inverse transform unit 802 is configured to perform inverse quantization/inverse orthogonal transform processing on the texture information received from the texture information decoding unit 801 so as to generate a decoded differential signal, and to supply the decoded differential signal thus generated to the adder unit 804.

The adder unit 804 is configured to generate a decoded image by performing addition of the intra predicted image and the decoded differential signal, to store the decoded image thus generated in the decoded image memory 805, and to output the decoded image.

The intra prediction mode encoding and the decoding processing according to the embodiment of the present invention are executed at, respectively, the intra prediction mode encoding unit 508 of the moving image encoding apparatus shown in FIG. 5 and the intra prediction mode decoding unit 803 of the moving image decoding apparatus shown in FIG. 8. Detailed description will be made below regarding the intra prediction mode encoding and decoding processing according to the embodiment.

### [Encoding Block]

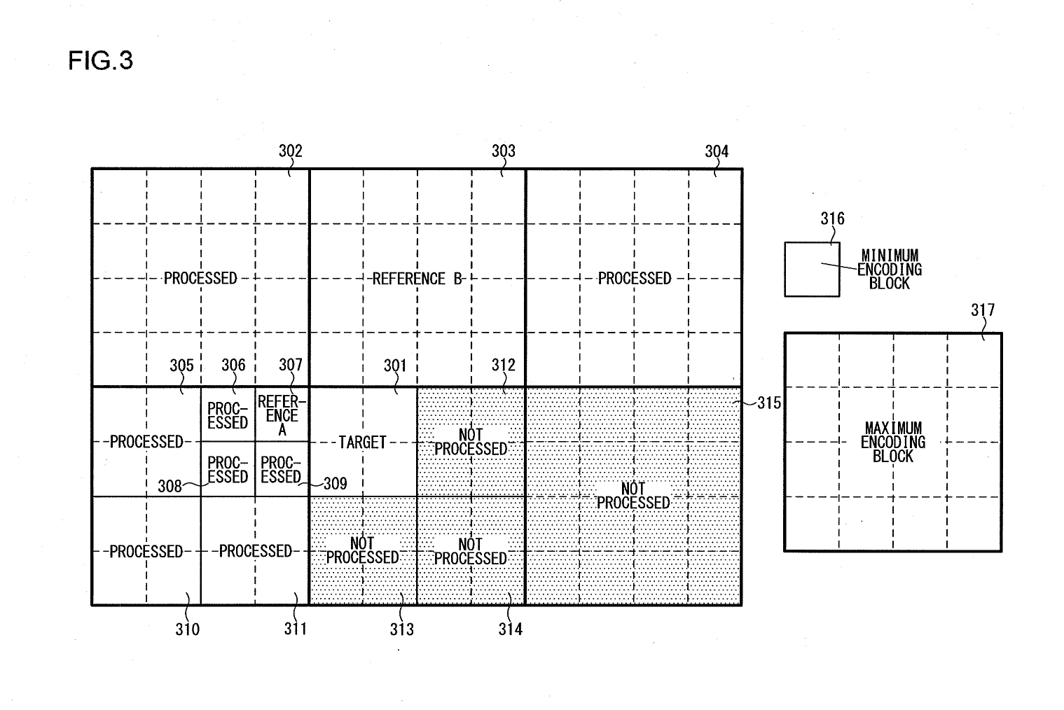

With the embodiment, as shown in FIG. 3, the frame is divided into rectangular blocks in a hierarchical manner, and processing is sequentially performed on the respective blocks in a predetermined order. Here, each block thus divided will be referred to as an “encoding block”. The block 317 shown in FIG. 3 is the maximum division unit block in the present embodiment, and will be referred to as the “maximum encoding block”. In contrast, the block 316 shown in FIG. 3 is the minimum division block in the present embodiment, and will be referred to as the “minimum encoding block”. Description will be made below assuming that the minimum encoding block is configured as 4 by 4 pixel matrix, and the maximum encoding block is configured as 16 by 16 pixel matrix.

### [Prediction Block]

Intra prediction is performed in units of blocks which will be referred to as “prediction blocks”, each of which is configured as the aforementioned encoding block. The prediction block has a matrix size that is equal to or greater than the matrix size of the minimum encoding block, and is equal to or smaller than the matrix size of the maximum encoding block. FIG. 3 shows an example in which the blocks 302, 303, and 304, are each configured as a 16 by 16 block, the blocks 305, 310, 311, and 301 are each configured as an 8 by 8 block, and the blocks 306, 307, 308, and 309, are each configured as a 4 by 4 block. The blocks 312, 313, 314, and 315, have not yet been processed, and the encoding block size has not yet been determined for these blocks. In the encoding procedure, an optimum prediction block size is determined, and the prediction block size thus determined is transmitted. In the decoding procedure, the prediction block size is acquired from the bit stream. Description will be made below assuming that processing is performed in units of prediction blocks.

### [Color Difference Component of Block]

Description will be made in the embodiment regarding an arrangement employing the YUV4:2:0 format. In the embodiment, the color difference component for an 8 by 8 block and the color difference component for a 16 by 16 block are configured as a 4 by 4 pixel matrix and an 8 by 8 pixel matrix, respectively. In a case of handling a 4 by 4 block, a single color difference block configured as a 4 by 4 pixel matrix is associated with an 8 by 8 luminance pixel region formed of four 4 by 4 blocks.

### [Reference Block and Reference Intra Prediction Mode]

As a reference block, such an arrangement selects the block A, which is adjacent to the left side of the processing target block and is positioned in the uppermost position, and the block B, which is adjacent to the upper side of the processing target block and is positioned in the leftmost position. The prediction mode using the luminance component of the block A will be referred to as “refModeA”, and the prediction mode using the luminance component of the block B will be referred to as “refModeB”. When there is no reference block, the reference intra prediction mode for the luminance component is set to the average prediction mode (which will also be referred to as the “direct prediction mode”). In contrast, the intra prediction mode using each reference block will be referred to as the “reference intra prediction mode”.

### [Relation Between Prediction Block Size and Luminance Intra Prediction Mode]

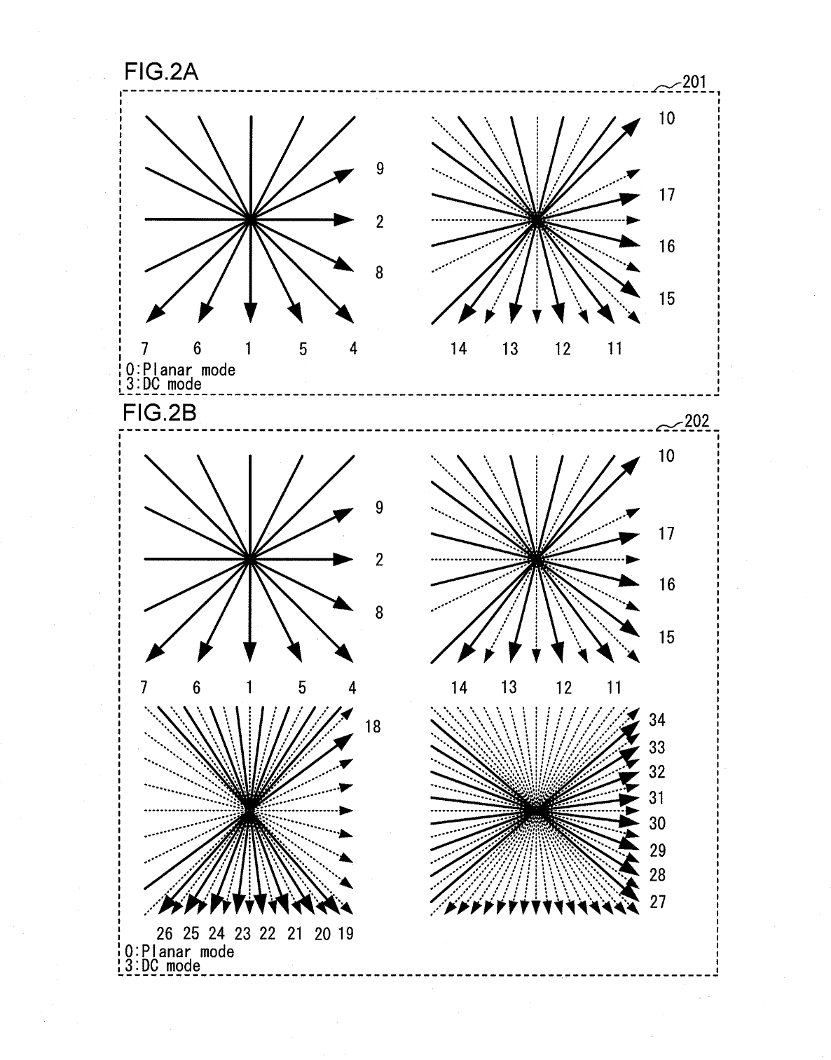

The configuration of the intra prediction mode is switched according to the prediction block size. When a 4 by 4 block is used for the luminance component, 18 patterns for intra prediction modes indicated by the reference numeral 201 shown in FIG. 2A are defined. In contrast, when an 8 by 8 block or a 16 by 16 block is used for the luminance component, 35 patterns for intra prediction modes indicated by the reference numeral 202 shown in FIG. 2B are defined. This is because an excessive number of patterns for intra prediction modes defined for a small-size prediction block does not improve the image quality commensurate with the increased code quantity involved in such an excessive number of patterns for intra prediction modes.

### [Intra Prediction Mode for Color Difference Block]

For the color difference block, two modes are further defined, in addition to the intra prediction modes for the luminance component.

DM mode: As the DM mode, the intra prediction mode for the luminance component is employed as it is.

LM mode: Error analysis is performed between a peripheral region in which the luminance component has been decoded and a peripheral region in which the color difference component has been decoded, and a conversion parameter is calculated such that the difference between them becomes minimal. The decoded image of the luminance target block is converted using the conversion parameter thus calculated, and the image thus converted is used as a prediction image for the color difference component.

### First Embodiment

### [Encoding Procedure]

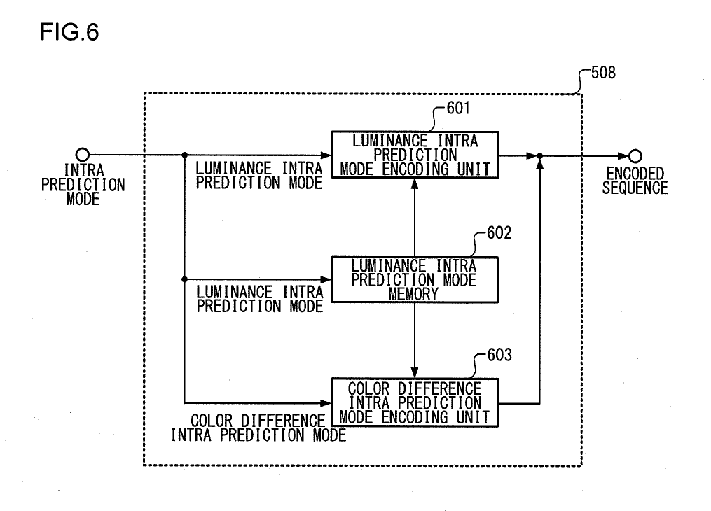

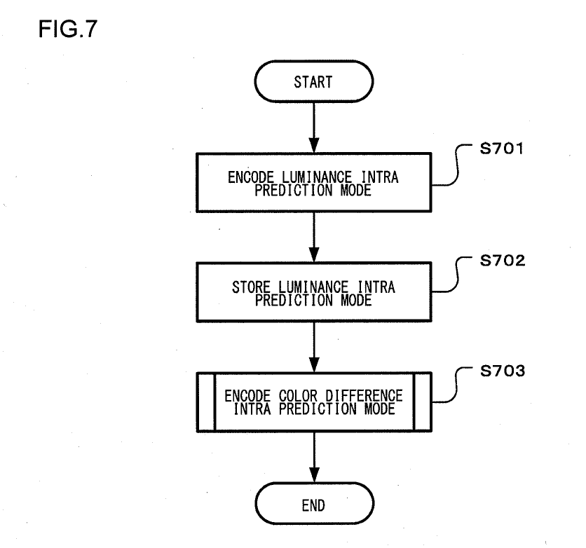

Description will be made regarding a first example of an encoding method for the intra prediction mode according to the embodiment of the present invention. FIG. 6 is a block diagram which shows a detailed configuration of the intra prediction mode encoding unit 508 shown in FIG. 5. The intra prediction mode encoding unit 508 includes a luminance intra prediction mode encoding unit 601, luminance intra prediction mode memory 602, and a color difference intra prediction mode encoding unit 603. Description will be made below regarding the encoding procedure for the intra prediction mode with reference to the flowchart shown in FIG. 7.

The luminance intra prediction mode encoding unit 601 acquires the luminance intra prediction modes refModeA and refModeB for the adjacent blocks from the luminance intra prediction mode memory 602, and encodes the luminance intra prediction mode for the target block according to a predetermined procedure (Step S701). With the present procedure, such an arrangement uses a spatial correlation of luminance intra prediction modes, referring to the luminance intra prediction modes refModeA and refModeB for the adjacent blocks, thereby providing improved compression efficiency. However, this is not the essence of the embodiment of the present invention, and accordingly, detailed description thereof will be omitted.

The luminance intra prediction mode memory 602 stores the luminance intra prediction mode for the target block (Step S702), and the processing ends.

The color difference intra prediction mode encoding unit 603 acquires the color difference intra prediction mode for the target block and the luminance intra prediction mode for the same target block, encodes the color difference intra prediction mode for the target block (Step S703), and the processing ends.

Detailed description will be made below regarding a procedure for encoding the color difference intra prediction mode.

### [Color Difference Intra Prediction Mode Encoding Procedure]

The color difference intra prediction mode encoding unit 603 is configured to acquire the color difference intra prediction mode for the target block and the luminance intra prediction mode for the same target block, and to make a comparison between the color difference intra prediction mode for the target block and the luminance intra prediction mode for the same target block thus acquired.

When the color difference intra prediction mode for the target block is the same as the luminance intra prediction mode for the same target block, the color difference prediction mode determination information is set to 0. By performing predetermined variable-length encoding processing on the color difference prediction mode determination information, such an arrangement is configured to generate a code sequence of the color difference prediction mode determination information. Examples of such variable-length encoding employed in the present embodiment include arithmetic coding, Huffman coding, etc., which allows such an arrangement to assign a short code to the color difference prediction mode determination information having a small value.

When the color difference intra prediction mode for the target block is not the same as the luminance intra prediction mode for the same target block, further judgment is made whether or not the color difference intra prediction mode for the target block is equivalent to the LM mode. When the color difference intra prediction mode for the target block is equivalent to the LM mode, the color difference prediction mode determination information is set to 1. When the color difference prediction mode for the target block differs from the LM mode, judgment is made based upon the value of the color difference intra prediction mode and the value of the luminance intra prediction mode.

When the luminance intra prediction mode is smaller than 4, and the color difference intra prediction mode is equal to 4, the color difference prediction mode determination information is set to (luminance intra prediction mode +2). By performing predetermined variable-length encoding processing on the color difference prediction mode determination information, such an arrangement is configured to generate a code sequence of the color difference prediction mode determination information.

When the luminance intra prediction mode is equal to or greater than 4, or when the color difference intra prediction mode differs from 4, the color difference prediction mode determination information is set to (color difference intra prediction mode +2). By performing predetermined variable-length encoding processing on the color difference prediction mode determination information, such an arrangement is configured to generate a code sequence of the color difference prediction mode determination information.

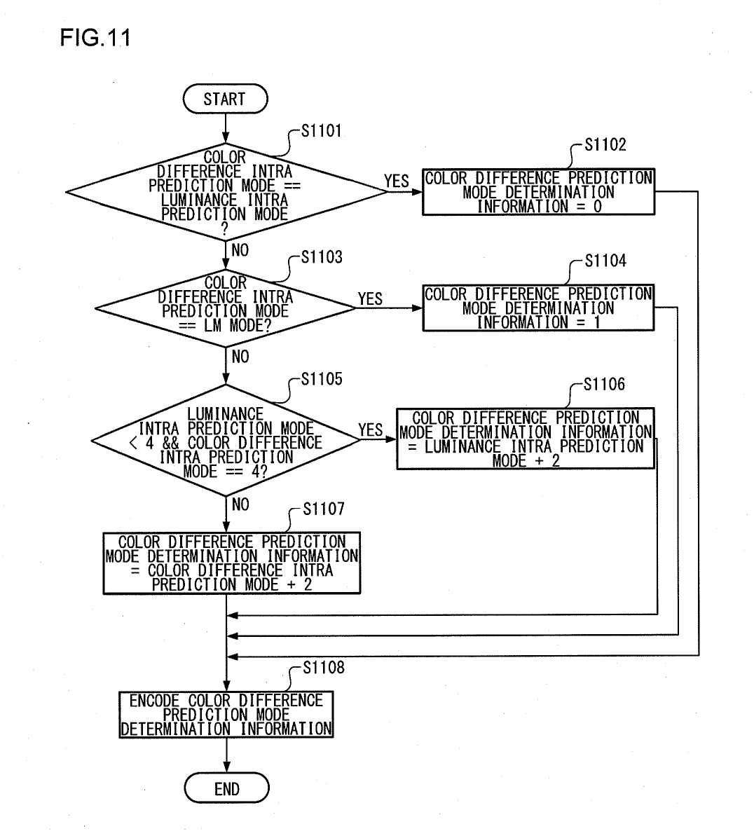

Detailed description will be made with reference to the flowchart shown in FIG. 11 regarding the color difference intra prediction mode encoding procedure performed in Step S703 shown in FIG. 7.

The color difference intra prediction mode encoding unit 603 acquires the color difference intra prediction mode for the target block and the luminance intra prediction mode for the same target block, and makes a comparison between the color difference intra prediction mode for the target block and the luminance intra prediction mode for the same target block (Step S1101). When the color difference intra prediction mode for the target block is the same as the luminance intra prediction mode for the same target block, the flow proceeds to Step S1102. Otherwise, the flow proceeds to Step S1103.

When the color difference intra prediction mode for the target block is the same as the luminance intra prediction mode for the same target block, the color difference prediction mode determination information is set to 0 (Step S1102), and the flow proceeds to Step S1108.

When the color difference intra prediction mode for the target block differs from the luminance intra prediction mode for the same target block, judgment is made whether or not the color difference intra mode is equivalent to the LM mode (Step S1103). When judgment is made that the color difference intra prediction mode is equivalent to the LM mode, the flow proceeds to Step S1104. Otherwise, the flow proceeds to Step S1105.

When the color difference intra prediction mode is equivalent to the LM mode, the color difference prediction mode determination information is set to 1 (Step S1104), and the flow proceeds to Step S1108.

When the color difference intra prediction mode is not equivalent to the LM mode, judgment is made based upon the value of the luminance intra prediction mode and the value of the color difference intra prediction mode (Step S1105). When the luminance intra prediction mode is smaller than 4, and the color difference intra prediction mode is equal to 4, the flow proceeds to Step S1106. Otherwise, the flow proceeds to Step S1107.

When the luminance intra prediction mode is smaller than 4, and the color difference intra prediction mode is equal to 4, the color difference prediction mode determination information is set to a value obtained by adding 2 to the luminance intra prediction mode (Step S1106), and the flow proceeds to Step S1108

When the luminance intra prediction mode is not smaller than 4, or when the color difference intra prediction mode is not equal to 4, the color difference prediction mode determination information is set to a value obtained by adding 2 to the color difference intra prediction mode (Step S1107), and the flow proceeds to Step S1108.

The color difference prediction mode determination information is subjected to variable-length coding so as to generate a code sequence of the color difference prediction mode determination information (Step S1108), and the processing ends. Examples of such variable-length encoding employed in the present embodiment include arithmetic coding, Huffman coding, etc., which allows such an arrangement to assign a short code to the color difference prediction mode determination information having a small value.

### [Decoding Procedure]

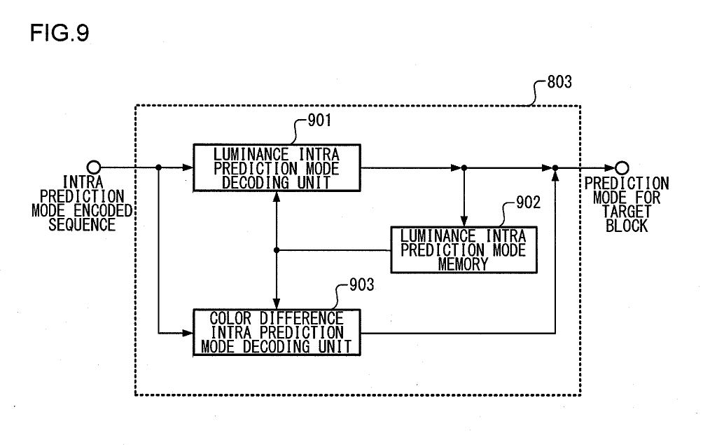

Description will be made regarding a first example of a decoding method for the intra prediction mode according to the embodiment of the present invention. FIG. 9 is a block diagram which shows a detailed configuration of the intra prediction mode decoding unit 803 shown in FIG. 8. The intra prediction mode decoding unit 803 includes a luminance intra prediction mode decoding unit 901, luminance intra prediction mode memory 902, and a color difference intra prediction mode decoding unit 903.

The intra prediction mode decoding processing performed by the intra prediction mode decoding unit 803 shown in FIG. 9 corresponds to the intra prediction mode encoding processing performed by the intra prediction mode encoding unit 508 shown in FIG. 6. Accordingly, the luminance intra prediction mode memory 902 shown in FIG. 9 has the same function as that of the luminance intra prediction mode memory 602 shown in FIG. 6.

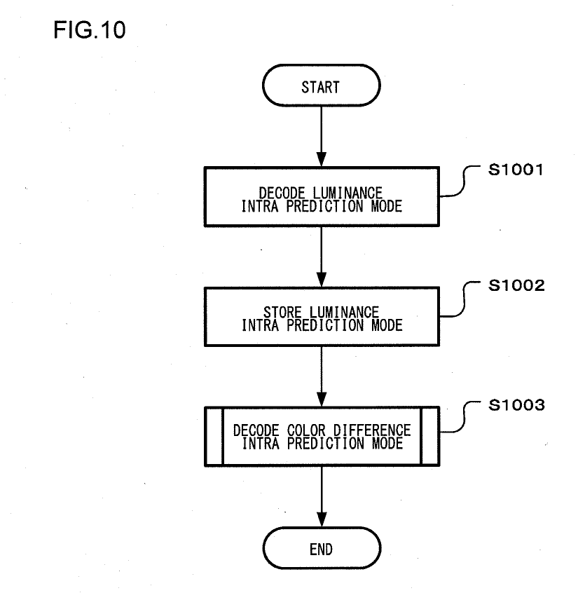

Description will be made with reference to the flowchart 10 shown in FIG. 10 regarding the decoding procedure for the intra prediction mode.

The luminance intra prediction mode decoding unit 901 acquires the luminance intra prediction modes refModeA and refModeB for adjacent blocks from the luminance intra prediction mode memory 902, and the intra prediction mode for the luminance component is decoded according to a predetermined procedure (Step S1001). Detailed description will be omitted.

The luminance intra prediction mode memory 902 stores the luminance intra prediction mode for the target block (Step S1002).

The color difference intra prediction mode decoding unit 903 acquires the luminance intra prediction mode for the same target block from the luminance intra prediction mode memory 902. Furthermore, the color difference intra prediction mode decoding unit 903 decodes the intra prediction mode code sequence so as to calculate the color difference intra prediction mode for the target block (Step S1003), and the processing ends.

Detailed description will be made below regarding the color difference intra prediction mode decoding procedure.

### [Color Difference Intra Prediction Mode Decoding Procedure]

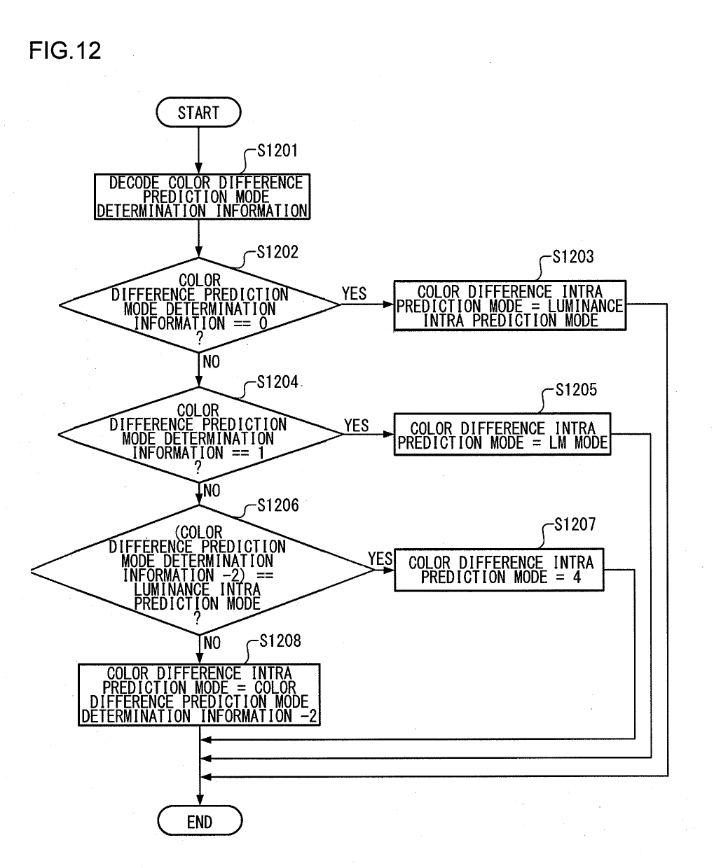

Detailed description will be made with reference to the flowchart shown in FIG. 12 regarding the color difference intra prediction mode decoding procedure performed in Step S1003 shown in FIG. 10.

The color difference intra prediction mode decoding unit 903 acquires the color difference prediction mode determination information code sequence, and acquires the decoded luminance intra prediction mode for the decoding target block from the luminance intra prediction mode memory 902. Furthermore, predetermined variable-length decoding processing is performed on the color difference prediction mode determination information code sequence, thereby generating the color difference prediction mode determination information (Step S1201). Examples of such variable-length decoding to be applied include arithmetic coding, Huffman coding, etc., which allows such an arrangement to assign a short code to the color difference prediction mode determination information having a small value.

Judgment is made based upon the value of the color difference prediction mode determination information (Step S1202). When the value of the color difference prediction mode determination information is 0, the color difference intra prediction mode is set to the same value as that of the luminance intra prediction mode (Step S1203), and the processing ends.

When the value of the color difference prediction mode determination information is not 0, further judgment is made based upon the value of the color difference prediction mode determination information (Step S1204). When the value of the color difference prediction mode determination information is 1, the color difference intra prediction mode is set to the LM mode (Step S1205), the processing ends.

When the value of the color difference prediction mode determination information is equal to or greater than 2, a comparison is made between the value of the color difference prediction mode determination information and the value of the luminance intra prediction mode (Step S1206).

When the value (color difference prediction mode determination information −2) and the value of the luminance intra prediction mode are equivalent, the color difference intra prediction mode is set to a predetermined value (Step S1207), and the processing ends. With the present embodiment, the intra prediction mode 4 shown in FIG. 2 (which indicates the direction sloping at a 45 degree angle toward the lower right) is employed as the predetermined value. However, the intra prediction mode to be set in this situation is not restricted to 4. Rather, other modes may be employed as the intra prediction mode to be set in this situation (e.g., the mode 7 which represents the direction sloping at a 45 degree angle toward the lower left).

When the value (color difference prediction mode determination information −2) and the value of the luminance intra prediction mode differ, the color difference intra prediction mode is set to the value (color difference mode determination information −2) (Step S1208), and the processing ends.

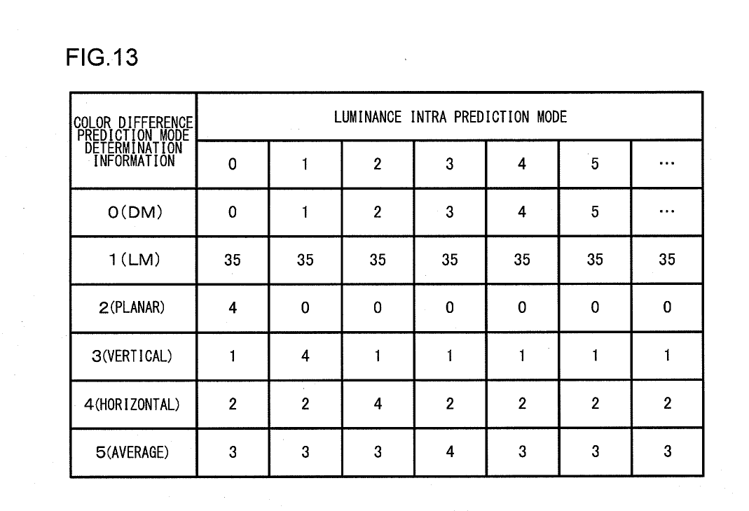

FIG. 13 shows the mapping table which shows the relation between the color difference prediction mode determination information and the color difference intra prediction mode according to the present embodiment. In the mapping table shown in FIG. 13, the color difference prediction mode determination information 0, 1, 2, 3, 4, and 5, correspond to the DM mode, LM mode, planar mode, vertical mode, horizontal mode, and average mode, respectively.

The color difference prediction mode determination information 0 represents the DM mode. As the color difference intra prediction mode, the value of the luminance intra prediction mode is employed as it is. There is a high probability that the color difference intra prediction mode is equivalent to the luminance intra prediction mode. Thus, by assigning the DM mode to the color difference prediction mode determination information 0, such an arrangement provides a reduced average code quantity.

The color difference prediction mode determination information 1 is equivalent to the LM mode. In this case, the color difference intra prediction mode is set to the LM mode regardless of the value of the luminance intra prediction mode.

The color difference prediction mode determination information 2, 3, 4, and 5, basically correspond to the intra prediction modes 0 (planar mode), 1 (vertical mode), 2 (horizontal mode), and 3 (average mode), respectively. However, when the color difference intra prediction mode is the same as the luminance intra prediction mode, the color difference prediction mode determination information 0 (DM mode) is assigned to the color difference intra prediction mode beforehand. Thus, there is a redundancy in such a basic arrangement. Specifically, this redundancy is that the intra prediction mode 0 (planar mode) is again assigned to the color difference prediction mode determination information 2 when the luminance intra prediction mode is 0, the intra prediction mode 1 (vertical mode) is again assigned to the color difference prediction mode determination information 3 when the luminance intra prediction mode is 1, the intra prediction mode 2 (horizontal mode) is again assigned to the color difference prediction mode determination information 4 when the luminance intra prediction mode is 2, and the intra prediction mode 3 (DC mode) is again assigned to the color difference prediction mode determination information 5 when the luminance intra prediction mode is 3.

With the present configuration, another intra prediction mode 4 (sloping at a 45 degree angle toward the lower right) is assigned to the color difference prediction mode determination information 2 when the luminance intra prediction mode is 0, the color difference prediction mode determination information 3 when the luminance intra prediction mode is 1, the color difference prediction mode determination information 4 when the luminance intra prediction mode is 2, and the color difference prediction mode determination information 5 when the luminance intra prediction mode is 3. Thus, such an arrangement provides improved coding efficiency without redundancy.

The necessary condition for such an intra prediction mode to be assigned to the color difference prediction mode determination information 2 when the luminance intra prediction mode is 0, the color difference prediction mode determination information 3 when the luminance intra prediction mode is 1, the color difference prediction mode determination information 4 when the luminance intra prediction mode is 2, and the color difference prediction mode determination information 5 when the luminance intra prediction mode is 3, is that the relevant intra prediction mode is one that is not assigned to other color difference prediction mode determination information. That is to say, such an intra prediction mode to be assigned in this situation is not restricted to mode 4. By assigning a prediction mode having higher correlativity with changing according to the value of the luminance intra prediction mode, e.g., an adjacent mode of the luminance intra prediction mode, such an arrangement is capable of having a higher probability of selecting a suitable prediction mode, thereby improving the coding efficiency.

### Second Embodiment

Description will be made regarding a second example of the encoding method for the intra prediction mode according to the embodiment of the present invention. The only point of difference between the first embodiment and the second embodiment is the encoding/decoding procedures for the color difference intra prediction mode. Description will be made below regarding the encoding/decoding procedures for the color difference intra prediction mode according to the present embodiment.

### [Color Difference Intra Prediction Mode Encoding Procedure]

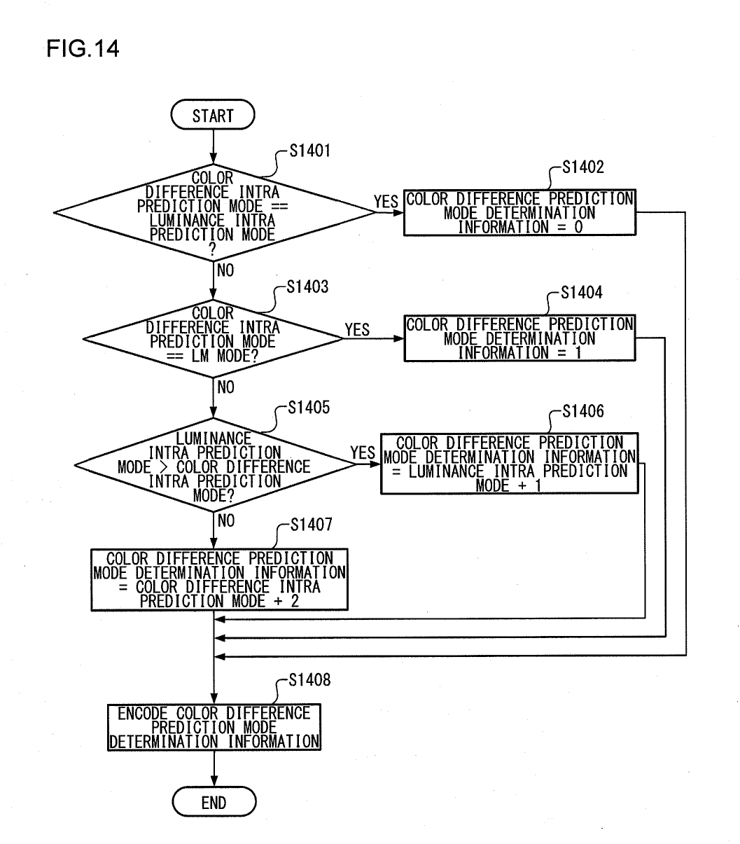

Detailed description will be made with reference to the flowchart shown in FIG. 14 regarding the encoding procedure for the color difference intra prediction mode performed in Step S703 in FIG. 7.

The color difference intra prediction mode encoding unit 603 acquires the color difference intra prediction mode for the target block and the luminance intra prediction mode for the same target block, and makes a comparison between the color difference intra prediction mode for the target block and the luminance intra prediction mode for the same target block (Step S1401).

When the color difference intra prediction mode for the target block is equivalent to the luminance intra prediction mode for the same target block, the color difference prediction mode determination information is set to 0 (Step S1402). Predetermined variable-length encoding processing is performed on the color difference prediction mode determination information so as to generate the code sequence of the color difference prediction mode determination information (Step S1408), and the processing ends. With the present embodiment, examples of such variable-length encoding to be applied include arithmetic coding, Huffman coding, etc., in the same way as in the first embodiment, which allows such an arrangement to assign a short code to the color difference prediction mode determination information having a small value.

When judgment is made in Step S1401 that the color difference intra prediction mode for the target block is not the same as the luminance intra prediction mode for the same target block, further judgment is made whether or not the color difference intra prediction mode for the target block is equivalent to the LM mode (Step S1403).

When the color difference intra prediction mode for the target block is equivalent to the LM mode, the color difference prediction mode determination information is set to 1 (Step S1404).

When the color difference intra prediction mode for the target block differs from the LM mode, the value of the color difference intra prediction mode is compared with the value of the luminance intra prediction mode (Step S1405).

When the luminance intra prediction mode is greater than the color difference intra prediction mode, the color difference prediction mode determination information is set to (luminance intra prediction mode +1) (Step S1406). Predetermined variable-length encoding processing is performed on the color difference prediction mode determination information so as to generate the code sequence of the color difference prediction mode determination information (Step S1408), and the processing ends.

When the luminance intra prediction mode is equal to or smaller than the color difference intra prediction mode, the color difference prediction mode determination information is set to (luminance intra prediction mode +2) (Step S1407). Predetermined variable-length encoding processing is performed on the color difference prediction mode determination information so as to generate the code sequence of the color difference prediction mode determination information (Step S1408), and the processing ends.

### [Color Difference Intra Prediction Mode Decoding Procedure]

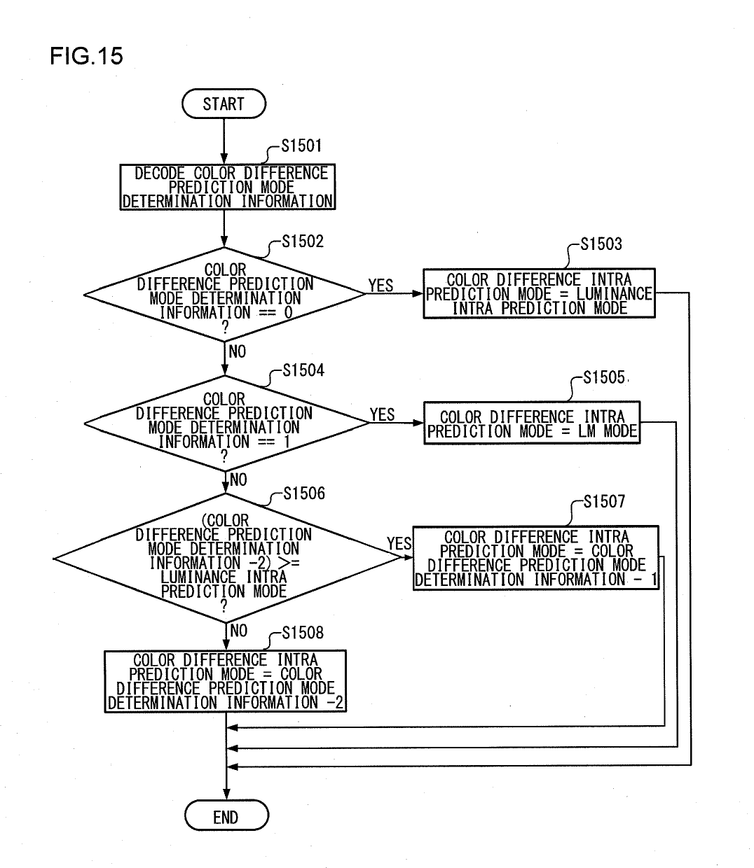

Detailed description will be made with reference to the flowchart shown in FIG. 15 regarding the color difference intra prediction mode decoding procedure performed in Step S1003 shown in FIG. 10.

The color difference intra prediction mode decoding unit 903 acquires the color difference prediction mode code sequence, and acquires the decoded luminance intra prediction mode for the decoding target block from the luminance intra prediction mode memory 902. Predetermined variable-length decoding processing is performed on the color difference prediction mode determination information code sequence so as to generate the color difference prediction mode determination information (Step S1501). Examples of such variable-length decoding employed in the present embodiment include arithmetic coding, Huffman coding, etc., which allows such an arrangement to assign a short code to the color difference prediction mode determination information having a small value.

Judgment is made based upon the value of the color difference prediction mode determination information (Step S1502). When the value of the color difference prediction mode determination information is 0, the color difference intra prediction mode is set to the same value as that of the luminance intra prediction mode (Step S1503), and the processing ends.

When the value of the color difference mode determination information is not 0, further judgment is made based upon the value of the color difference prediction mode determination information (Step S1505). When the value of the color difference prediction mode determination information is 1, the color difference intra prediction mode is set to the LM mode (Step S1505), and the processing ends.

When the value of the color difference prediction mode determination information is equal to or greater than 2, a comparison is made between the value of the color difference prediction mode determination information and the value of the luminance intra prediction mode (Step S1506).

When the value (color difference prediction mode determination information −2) is equal to or greater than the value of the luminance intra prediction mode, the color difference intra prediction mode is set to (color difference prediction mode determination information −1) (Step S1507), and the processing ends.

When the value (color difference prediction mode determination information −2) is smaller than the value of the luminance intra prediction mode, the color difference intra prediction mode is set to (color difference prediction mode determination information −2) (Step S1508), and the processing ends.

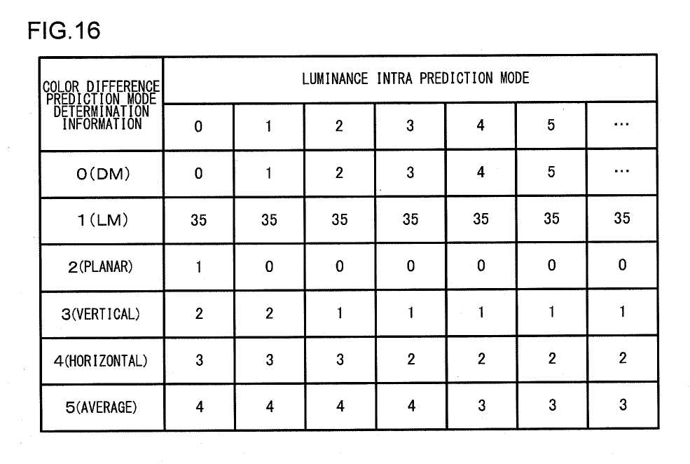

FIG. 16 shows the mapping table which shows the relation between the color difference prediction mode determination information and the color difference intra prediction mode according to the present embodiment. In the mapping table shown in FIG. 16, the color difference prediction mode determination information 0, 1, 2, 3, 4, and 5, correspond to the DM mode, LM mode, planar mode, vertical mode, horizontal mode, and average mode, respectively.

Such an arrangement is configured to assign the color difference prediction mode to the color difference prediction mode determination information 0 and 1 in the same manner as that in the embodiment 1 shown in FIG. 13.

The color difference prediction mode determination information 2, 3, 4, and 5, are basically associated with the intra prediction modes 0 (planer mode), 1 (vertical mode), 2 (horizontal mode), and 3 (average mode), respectively. However, when the color difference intra prediction mode is the same as the luminance intra prediction mode, the color difference prediction mode determination information 0 (DM mode) is assigned to the color difference intra prediction mode beforehand. Thus, there is a redundancy in such a basic arrangement. Specifically, this redundancy is that the intra prediction mode 0 (planner mode) is again assigned to the color difference prediction mode determination information 2 when the luminance intra prediction mode is 0, the intra prediction mode 1 (vertical mode) is again assigned to the color difference prediction mode determination information 3 when the luminance intra prediction mode is 1, the intra prediction mode 2 (horizontal mode) is again assigned to the color difference prediction mode determination information 4 when the luminance intra prediction mode is 2, and the intra prediction mode 3 (DC mode) is again assigned to the color difference prediction mode determination information 5 when the luminance intra prediction mode is 3.

There is a redundancy in that, when the value of the color difference prediction mode is the same as that of the luminance intra prediction mode, the color difference prediction mode is again assigned to the corresponding color difference prediction mode determination information 2, 3, 4, or 5. Thus, in such a situation, such an arrangement is configured to assign a value that differs from the value of the luminance intra prediction mode to the corresponding color difference prediction mode determination information 2, 3, 4, or 5, as with the first embodiment. However, there is a difference between the first embodiment and the second embodiment in the method of assigning the color difference prediction mode.

When the luminance intra prediction mode is 0, the color difference prediction modes 1, 2, 3, and 4, are assigned to the color difference prediction mode determination information 2, 3, 4, and 5, respectively.

When the luminance intra prediction mode is 1, the color difference prediction modes 0, 2, 3, and 4, are assigned to the color difference prediction mode determination information 2, 3, 4, and 5, respectively.

When the luminance intra prediction mode is 2, the color difference prediction modes 0, 1, 3, and 4, are assigned to the color difference prediction mode determination information 2, 3, 4, and 5, respectively.

When the luminance intra prediction mode is 3, the color difference prediction modes 0, 1, 2, and 4, are assigned to the color difference prediction mode determination information 2, 3, 4, and 5, respectively.

When the luminance intra prediction mode is 4 or more, the color difference prediction modes 0, 1, 2, and 3, are assigned to the color difference prediction mode determination information 2, 3, 4, and 5, respectively.

With the present embodiment, each color difference intra prediction mode can be calculated based upon the corresponding luminance intra prediction mode, as with the first embodiment. The point of difference from the first embodiment is that mode assignment is performed such that the color difference prediction mode determination information having a large value is assigned to a large mode number. The mode number is designed based upon the typical mode occurrence probability. Specifically, such an arrangement is configured such that a mode having a small mode number occurs with a high probability. The present embodiment is configured to assign the color difference prediction mode determination information to the mode number according to such a tendency of the mode occurrence probability. Thus, such an arrangement allows a short code to be assigned to the color difference prediction mode determination information which represents a mode that occurs with a high probability, as compared with the first embodiment. Thus, such an arrangement allows the generated code quantity to be reduced.

### Third Embodiment

Description will be made regarding a third example of the encoding method for the intra prediction mode according to the embodiment of the present invention. The only point of difference between the first embodiment and the third embodiment is the encoding/decoding procedures for the color difference intra prediction mode. Description will be made below regarding the encoding/decoding procedures for the color difference intra prediction mode according to the present embodiment.

### [Color Difference Intra Prediction Mode Encoding Procedure]

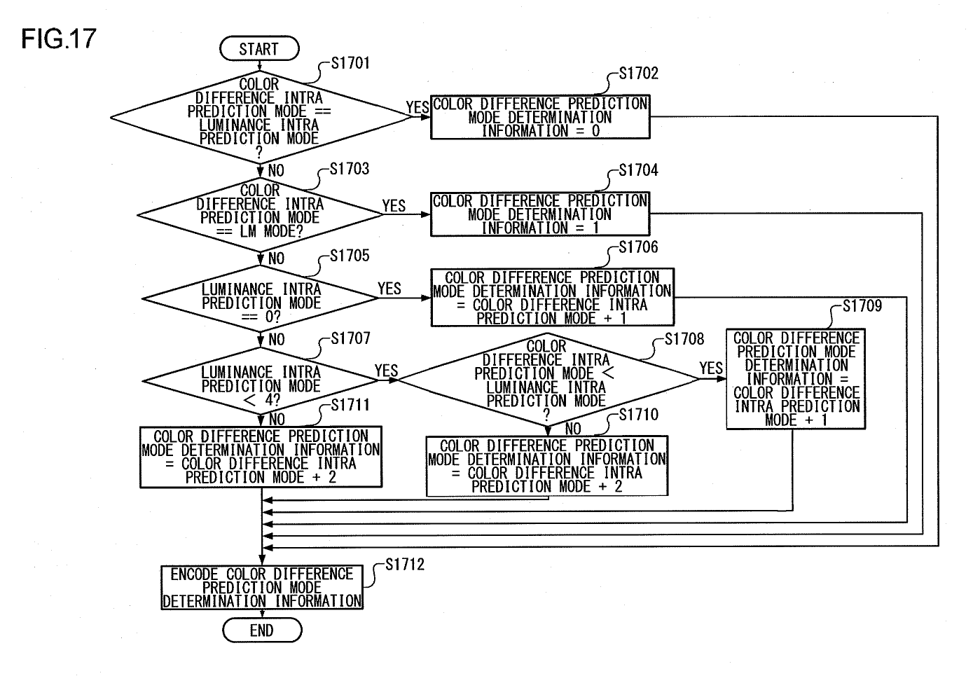

Detailed description will be made with reference to the flowchart shown in FIG. 17 regarding the encoding procedure for the color difference intra prediction mode performed in Step S703 in FIG. 7.

The color difference intra prediction mode encoding unit 603 acquires the color difference intra prediction mode for the target block and the luminance intra prediction mode for the same target block, and makes a comparison between the color difference intra prediction mode for the target block and the luminance intra prediction mode for the same target block (Step S1701).

When the color difference intra prediction mode for the target block is equivalent to the luminance intra prediction mode for the same target block, the color difference prediction mode determination information is set to 0 (Step S1702). Predetermined variable-length encoding processing is performed on the color difference prediction mode determination information so as to generate the code sequence of the color difference prediction mode determination information (Step S1712), and the processing ends. With the present embodiment, examples of such variable-length encoding to be applied include arithmetic coding, Huffman coding, etc., in the same way as in the first embodiment, which allows such an arrangement to assign a short code to the color difference prediction mode determination information having a small value.

When judgment is made in Step S1701 that the color difference intra prediction mode for the target block is not the same as the luminance intra prediction mode for the same target block, further judgment is made whether or not the color difference intra prediction mode for the target block is equivalent to the LM mode (Step S1703).

When the color difference intra prediction mode is equivalent to the LM mode, the color difference prediction mode determination information is set to 1 (Step S1704), and predetermined variable-length encoding processing is performed on the color difference prediction mode determination information thus set so as to generate a code sequence of the color difference prediction mode determination information (Step S1712), and the processing ends.

When the color difference intra prediction mode for the target block the LM mode in Step S1703, judgment is made based upon the value of the luminance intra prediction mode (Step S1705).

When the luminance intra prediction mode is 0, the color difference prediction mode determination information is set to (color difference intra prediction mode +1) (Step S1706). Predetermined variable-length encoding processing is performed on the color difference prediction mode determination information thus set so as to generate a code sequence of the color difference prediction mode determination information (Step S1712), and the processing ends.

When the luminance intra prediction mode is not 0 in Step S1705, further judgment is made based upon the value of the luminance intra prediction mode (Step S1707). When the luminance intra prediction mode is smaller than 4, a comparison is made between the value of the color difference intra prediction mode and the value of the luminance intra prediction mode (Step S1708).

When the value of the color difference intra prediction mode is smaller than the value of the luminance intra prediction mode, the color difference prediction mode determination information is set to (color difference intra prediction mode +1) (Step S1709). Predetermined variable-length encoding processing is performed on the color difference prediction mode determination information thus set so as to generate a code sequence of the color difference prediction mode determination information (Step S1712), and the processing ends.

When the value of the color difference intra prediction mode is greater than the value of the luminance intra prediction mode in Step S1708, the color difference prediction mode determination information is set to (color difference intra prediction mode +2) (Step S1710). Predetermined variable-length encoding processing is performed on the color difference prediction mode determination information thus set so as to generate a code sequence of the color difference prediction mode determination information (Step S1712), and the processing ends.

When the luminance intra prediction mode is equal to or greater than 4 in Step S1707, the color difference prediction mode determination information is set to (color difference intra prediction mode +2) (Step S1711). Predetermined variable-length encoding processing is performed on the color difference prediction mode determination information thus set so as to generate a code sequence of the color difference prediction mode determination information (Step S1712), and the processing ends.

### [Color Difference Intra Prediction Mode Decoding Procedure]

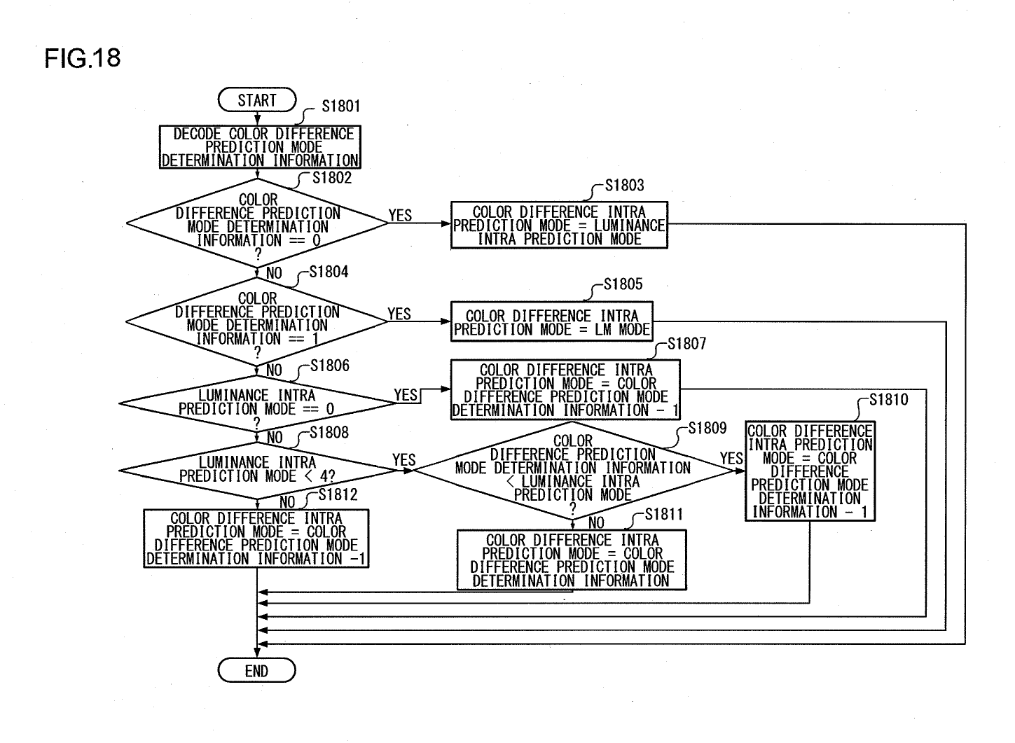

Detailed description will be made with reference to the flowchart shown in FIG. 18 regarding the color difference intra prediction mode decoding procedure performed in Step S1003 shown in FIG. 10.

The color difference intra prediction mode decoding unit 903 acquires the color difference prediction mode code sequence, and acquires the decoded luminance intra prediction mode for the decoding target block from the luminance intra prediction mode memory 902. Predetermined variable-length decoding processing is performed on the color difference prediction mode determination information code sequence so as to generate the color difference prediction mode determination information (Step S1801). Examples of such variable-length encoding employed in the present embodiment include arithmetic coding, Huffman coding, etc., which allows such an arrangement to assign a short code to the color difference prediction mode determination information having a small value.

Judgment is made based upon the value of the color difference prediction mode determination information (Step S1802). When the value of the color difference prediction mode determination information is 0, the color difference intra prediction mode is set to the same value as that of the luminance intra prediction mode (Step S1803), and the processing ends.

When the color difference mode determination information is not 0, further judgment is made based upon the value of the color difference prediction mode determination information (Step S1804). When the value of the color difference prediction mode determination information is 1, the color difference intra prediction mode is set to the LM mode (Step S1805), and the processing ends.

When the value of the color difference prediction mode determination information is equal to or greater than 2, judgment is made based upon the value of the luminance intra prediction mode (Step S1806).

When the luminance intra prediction mode is equal to 0, the color difference intra prediction mode is set to (color difference prediction mode determination information −1) (Step S1807), and the processing ends.

When the luminance intra prediction mode differs from 0 in Step S1806, further judgment is made based upon the value of the luminance intra prediction mode (Step S1808).

When the luminance intra prediction mode is smaller than 4, a comparison is made between the value of the color difference prediction mode determination information and the value of the luminance intra prediction mode (Step S1809).

When the color difference prediction mode determination information is smaller than the luminance intra prediction mode, the color difference intra prediction mode is set to (color difference prediction mode determination information −1) (Step S1810), and the processing ends.

When the color difference prediction mode determination information is greater than the luminance intra prediction mode, the color difference intra prediction mode is set to the color difference prediction mode determination information (Step S1811), and the processing ends.

When the luminance intra prediction mode is equal to or greater than 4 in Step S1808, the color difference intra prediction mode is set to (color difference prediction mode determination information −1) (Step S1812), and the processing ends.

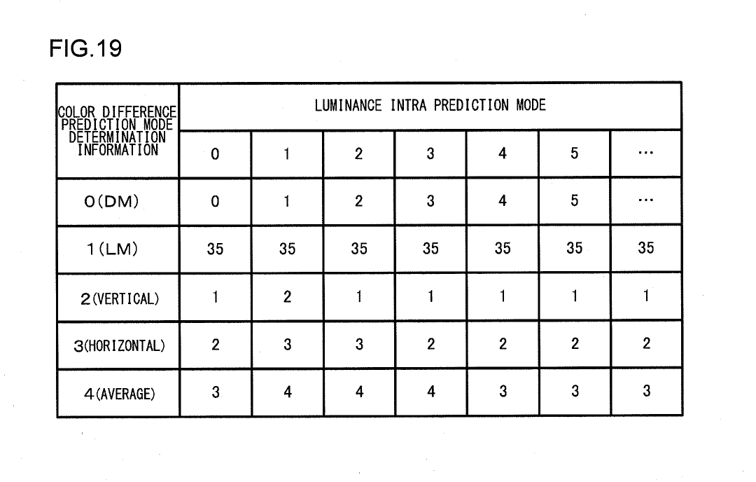

FIG. 19 shows the mapping table which shows the relation between the color difference prediction mode determination information and the color difference intra prediction mode according to the present embodiment. In the mapping table shown in FIG. 19, the color difference prediction mode determination information 0, 1, 2, 3, and 4, correspond to the DM mode, LM mode, vertical mode, horizontal mode, and average mode, respectively.

Such an arrangement is configured to assign the color difference prediction mode to the color difference prediction mode determination information 0 and 1 in the same manner as that in the embodiment 1 shown in FIG. 13.

The point of difference from the first and second embodiments is that the total number of color difference prediction mode determination information to be assigned when the luminance intra prediction mode is not 0 is reduced by 1, thereby reducing the generated average code quantity. With the present embodiment, in order to reduce the total number of color difference prediction mode determination information by 1, the color difference prediction mode that corresponds to the planar mode is eliminated.

The color difference prediction mode determination information 2, 3, and 4, basically correspond to the intra prediction modes 1 (vertical mode), 2 (horizontal mode), and 3 (DC mode), respectively. There is a redundancy in that, when the value of the color difference prediction mode is the same as that of the luminance intra prediction mode, the color difference prediction mode is again assigned to the corresponding color difference prediction mode determination information 2, 3, or 4. Thus, in such a situation, such an arrangement is configured to assign a value that differs from the value of the luminance intra prediction mode to the corresponding color difference prediction mode determination information 2, 3, or 4, as with the first and second embodiments. However, there is a difference in the method of assigning the color difference prediction mode between the third embodiment and the first embodiment and the second embodiment.

When the luminance intra prediction mode is equal to 0, the color difference prediction modes 1, 2, and 3, are assigned to the color difference prediction mode determination information 2, 3, and 4, respectively.

When the luminance intra prediction mode is equal to 1, the color difference prediction modes 2, 3, and 4, are assigned to the color difference prediction mode determination information 2, 3, and 4, respectively.

When the luminance intra prediction mode is equal to 2, the color difference prediction modes 1, 3, and 4, are assigned to the color difference prediction mode determination information 2, 3, and 4, respectively.

When the luminance intra prediction mode is equal to 3, the color difference prediction modes 1, 2, and 4, are assigned to the color difference prediction mode determination information 2, 3, and 4, respectively.

When the luminance intra prediction mode is equal to or greater than 4, the color difference prediction modes 1, 2, and 3, are assigned to the color difference prediction mode determination information 2, 3, and 4, respectively.

### Fourth Embodiment

Description will be made regarding a fourth example of the encoding method for the intra prediction mode according to the embodiment of the present invention. The only point of difference from the first embodiment is the encoding/decoding procedures for the color difference intra prediction mode. Description will be made below regarding the encoding/decoding procedures according to the present embodiment.

### [Color Difference Intra Prediction Mode Encoding Procedure]

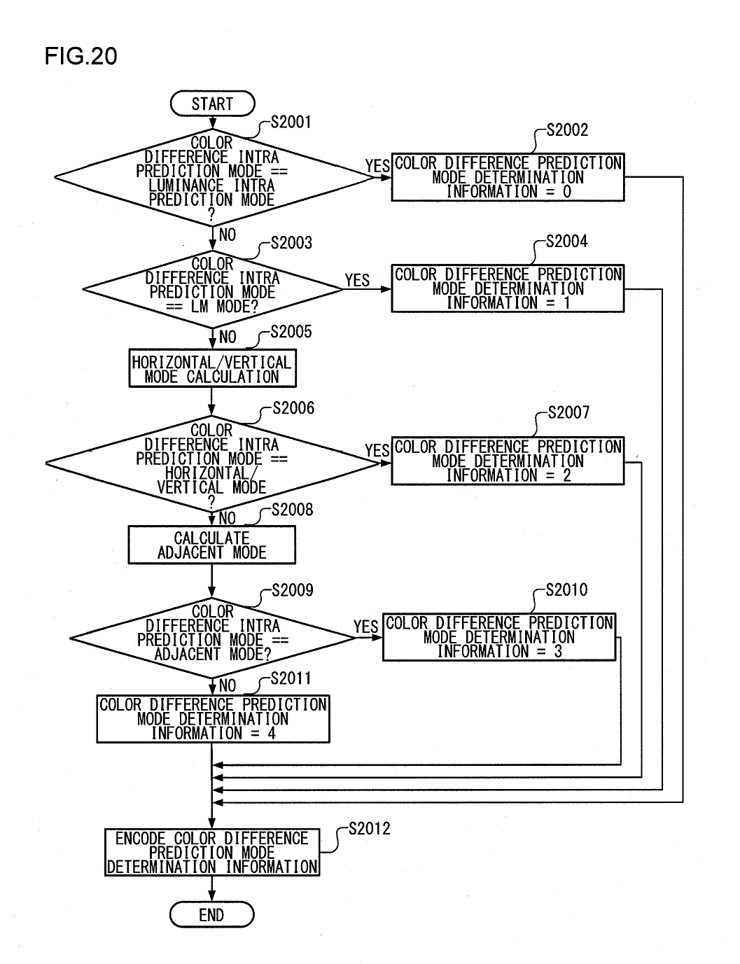

Detailed description will be made with reference to the flowchart shown in FIG. 20 regarding the encoding procedure for the color difference intra prediction mode performed in Step S703 in FIG. 7.

The color difference intra prediction mode encoding unit 603 acquires the color difference intra prediction mode for the target block and the luminance intra prediction mode for the same target block, and makes a comparison between the color difference intra prediction mode for the target block and the luminance intra prediction mode for the same target block (Step S2001).

When the color difference intra prediction mode for the target block is equivalent to the luminance intra prediction mode for the same target block, the color difference prediction mode determination information is set to 0 (Step S2002). Predetermined variable-length encoding processing is performed on the color difference prediction mode determination information so as to generate the code sequence of the color difference prediction mode determination information (Step S2012), and the processing ends. With the present embodiment, examples of such variable-length encoding to be applied include arithmetic coding, Huffman coding, etc., in the same way as in the first embodiment, which allows such an arrangement to assign a short code to the color difference prediction mode determination information having a small value.

When judgment is made in Step S2001 that the color difference intra prediction mode for the target block is not the same as the luminance intra prediction mode for the same target block, further judgment is made whether or not the color difference intra prediction mode for the target block is equivalent to the LM mode (Step S2003).

When the color difference intra prediction mode for the target block is equivalent to the LM mode, the color difference prediction mode determination information is set to 1 (Step S2004), predetermined variable-length encoding processing is performed on the color difference prediction mode determination information thus set so as to generate a code sequence of the color difference prediction mode determination information (Step S2012), and the processing ends.

When the color difference intra prediction mode for the target block differs from the LM mode in Step S2003, horizontal/vertical mode calculation is performed (Step S2005). With such an arrangement, a mode having a smaller angle between itself and the luminance intra prediction mode is selected from among the horizontal mode and the vertical mode, and the mode thus selected is set for the horizontal/vertical mode. Specifically, in FIG. 2, the horizontal mode is set for the mode 8 as the horizontal/vertical mode, and the vertical mode is set for the mode 14 as the horizontal/vertical mode. When the angle between the prediction mode and the horizontal mode is the same as the angle between the prediction mode and the vertical mode, i.e., when the target mode is the mode 4, 7, or 10, determination of which mode from among the horizontal mode and the vertical mode is used as the horizontal/vertical mode is made beforehand. Description will be made in the present embodiment regarding an arrangement in which the vertical mode is set for the modes 4, 7, and 10. Furthermore, from among the horizontal mode and the vertical mode, determination of which mode is used as the horizontal/vertical mode is made beforehand for the mode 0 (planar mode) and the mode 3 (average mode) each having no prediction direction, as with the modes 4, 7 and 10. Description will be made in the present embodiment regarding an arrangement in which the vertical mode is set for the modes 0 and 3. Furthermore, when the color difference intra prediction mode is equivalent to the horizontal mode, the horizontal/vertical mode is set to the vertical mode, and when the luminance intra prediction mode is equivalent to the vertical mode, the horizontal/vertical mode is set to the horizontal mode. This is because the color difference prediction mode determination information 0 is assigned beforehand to a case in which the luminance intra prediction mode and the color difference intra prediction mode are both equivalent to the horizontal mode (or vertical mode). Thus, there is a redundancy in that the horizontal mode (or vertical mode) is again assigned as the horizontal/vertical mode when the color difference intra prediction mode is equivalent to the horizontal mode (or vertical mode), which leads to an increase in redundancy, resulting in a reduction in the coding efficiency.

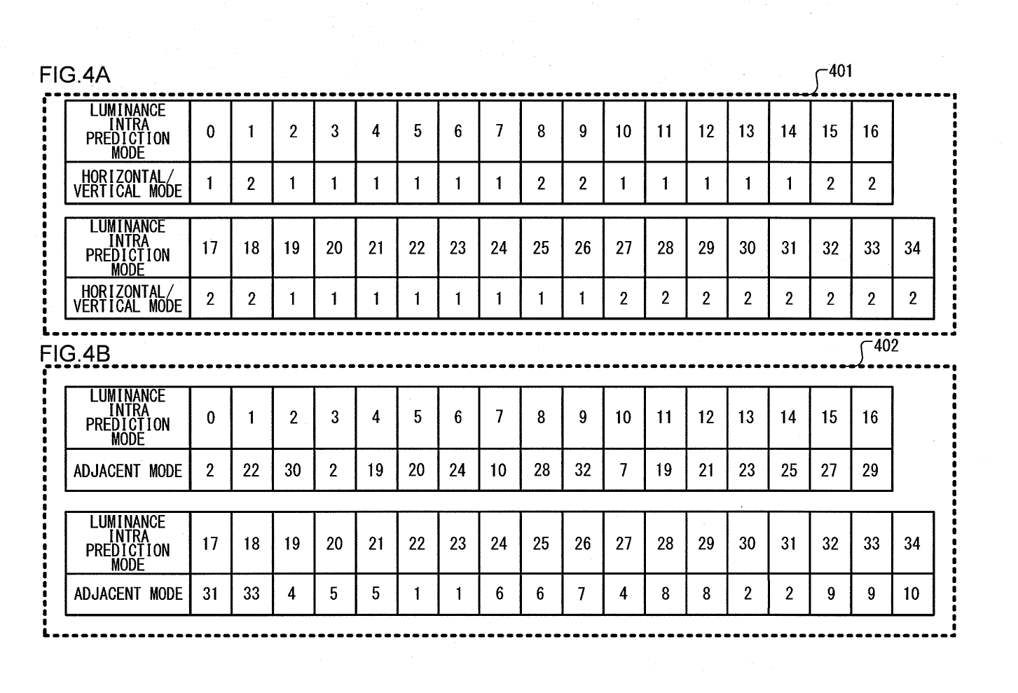

The horizontal/vertical mode determination procedure is realized by referring to a horizontal/vertical determination table 401 shown in FIG. 4A.

A comparison is made between the color difference intra prediction mode and the horizontal/vertical mode (Step S2006). When the color difference intra prediction mode is equivalent to the horizontal/vertical mode, the color difference prediction mode determination information is set to 2 (Step S2007), predetermined variable-length encoding processing is performed on the color difference prediction mode determination information so as to generate a code sequence of the color difference prediction mode determination information (Step S2012), and the processing ends.

When the color difference intra prediction mode differs from the horizontal/vertical mode in Step S2006, adjacent mode calculation is performed (Step S2008). As such an adjacent mode, a prediction mode having a prediction direction adjacent to that of the luminance intra prediction mode is employed. There are two adjacent prediction modes for each intra prediction mode. With the present embodiment, an adjacent prediction mode having a smaller mode number shown in FIG. 2 is selected as the adjacent mode from among the prediction modes adjacent to the luminance intra prediction mode. Furthermore, in order to perform mode calculation by means of shared steps, such an adjacent mode is set for the mode 0 (planar mode) and the mode 3 (average mode) each of which has no prediction direction. With the present embodiment, the adjacent mode is set to the mode 2 (horizontal mode) for the modes 0 and 3. The adjacent mode determination procedure is realized by referring to an adjacent mode determination table 402 shown in FIG. 4B.

A comparison is made between the color difference intra prediction mode and the adjacent mode (Step S2009). When the color difference intra prediction mode is equivalent to the adjacent mode, the color difference prediction mode determination information is set to 3 (Step S2010), predetermined variable-length encoding processing is performed on the color difference prediction mode determination information thus set so as to generate a code sequence of the color difference prediction mode determination information (Step S2012), and the processing ends.

When the color difference intra prediction mode differs from the adjacent mode in Step S2009, the color difference prediction mode determination information is set to 4 (Step S2011), predetermined variable-length encoding processing is performed on the color difference prediction mode determination information thus set so as to generate a code sequence of the color difference prediction mode determination information (Step S2012), and the processing ends.

### [Color Difference Intra Prediction Mode Decoding Procedure]

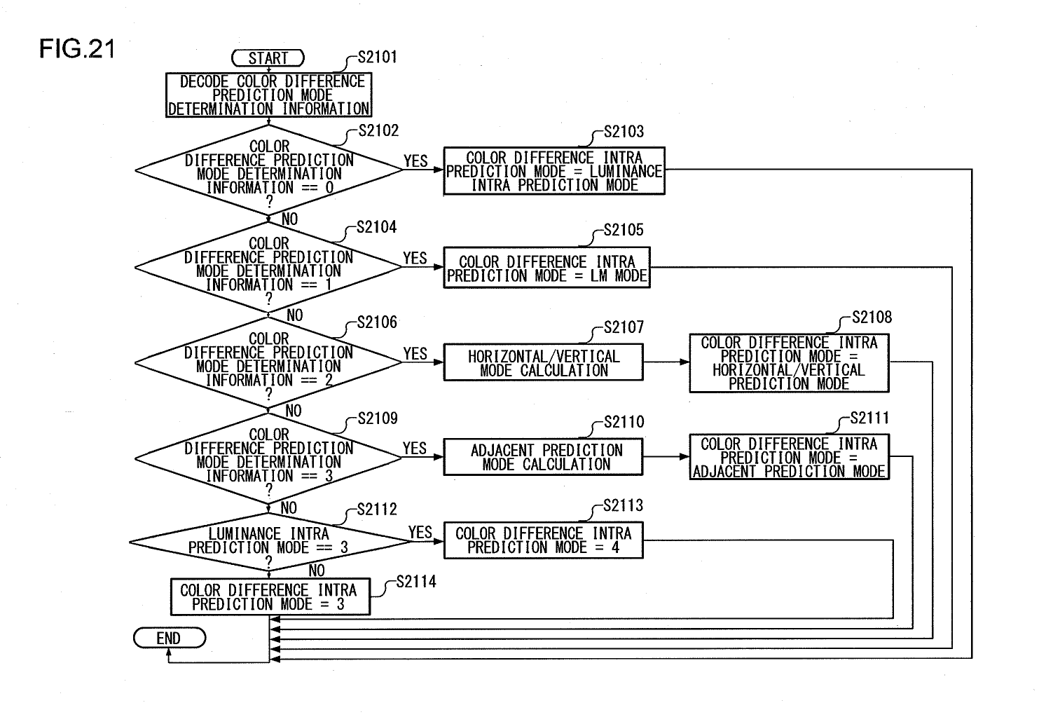

Detailed description will be made with reference to the flowchart shown in FIG. 21 regarding the color difference intra prediction mode decoding procedure performed in Step S1003 shown in FIG. 10.

The color difference intra prediction mode decoding unit 903 acquires the color difference prediction mode code sequence, and acquires the decoded luminance intra prediction mode for the decoding target block from the luminance intra prediction mode memory 902. Predetermined variable-length decoding processing is performed on the color difference prediction mode determination information code sequence so as to generate the color difference prediction mode determination information (Step S2101). Examples of such variable-length decoding employed in the present embodiment include arithmetic coding, Huffman coding, etc., which allows such an arrangement to assign a short code to the color difference prediction mode determination information having a small value.

Judgment is made based upon the value of the color difference prediction mode determination information (Step S2102). When the value of the color difference prediction mode determination information is 0, the color difference intra prediction mode is set to the same value as that of the luminance intra prediction mode (Step S2103), and the processing ends.

When the value of the color difference mode determination information is not 0, further judgment is made based upon the value of the color difference prediction mode determination information (Step S2104). When the value of the color difference prediction mode determination information is 1, the color difference intra prediction mode is set to the LM mode (Step S2105), and the processing ends.

When the value of the color difference prediction mode determination information is 2 (Step S2106), the horizontal/vertical mode calculation is performed (Step S2107). The horizontal/vertical mode calculation procedure is the same as the procedure performed in Step S2005 in FIG. 20, and accordingly description thereof will be omitted. The color difference intra prediction mode is set to the horizontal/vertical mode (Step S2108), and the processing ends.

When the value of the color difference prediction mode determination information is equal to 3 (Step S2109), the adjacent mode calculation is performed (Step S2110). The adjacent mode calculation procedure is the same as the procedure performed in Step S2008 shown in FIG. 20, and accordingly, description thereof will be omitted. The color difference intra prediction mode is set to the adjacent mode thus calculated (Step S2111), and the processing ends.

When the value of the color difference prediction mode determination information is greater than 3, judgment is made based upon the value of the luminance intra prediction mode (Step S2112). When the value of the luminance intra prediction mode is equal to 3, the color difference intra prediction mode is set to 4 (Step S2113), and the processing ends.

When the value of the luminance intra prediction mode is not 3, the color difference intra prediction mode is set to 3 (Step S2114), and the processing ends.

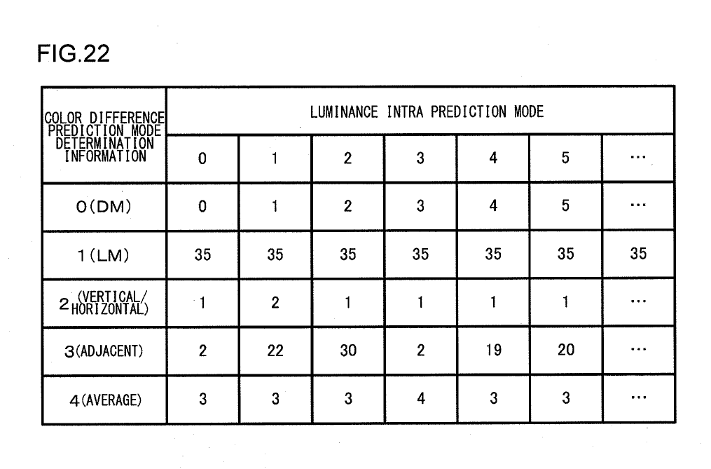

FIG. 22 shows the mapping table which shows the relation between the color difference prediction mode determination information and the color difference intra prediction mode according to the present embodiment. In the mapping table shown in FIG. 22, the color difference prediction mode determination information 0, 1, 2, 3, and 4, correspond to the DM mode, LM mode, horizontal/vertical mode, adjacent mode, and average mode, respectively.

Such an arrangement is configured to assign the color difference prediction mode to the color difference prediction mode determination information 0 and 1 in the same manner as that in the first embodiment shown in FIG. 13.

With the horizontal/vertical mode calculation, a mode having a smaller angle between itself and the luminance intra prediction mode is selected as the horizontal/vertical mode from among the horizontal mode and the vertical mode. There is a tendency for a prediction mode to occur with a high probability when there is a smaller difference in the prediction direction between the luminance intra prediction mode and the color difference intra prediction mode. In other words, either the horizontal mode or the vertical mode occurs with a lower probability. The horizontal/vertical mode calculation allows such a mode that occurs with a lower probability to be removed from the coding candidates. Thus, such an arrangement is capable of reducing the total number of color difference prediction mode determination information, thereby reducing the generated average code quantity.

With the adjacent mode calculation, an intra prediction mode adjacent to the prediction direction of the luminance intra prediction mode is set for the adjacent mode. The adjacent mode calculation is designed based upon the tendency for a prediction mode to occur with a high probability when there is a small difference in the prediction direction between the luminance intra prediction mode and the color difference intra prediction mode. Thus, such an arrangement allows modes having high correlativity to be selected as the coding candidates, thereby improving the coding quality.

Description has been made in the present embodiment regarding an arrangement in which a single adjacent intra prediction mode is selected as the adjacent mode from among the intra prediction modes adjacent to the prediction direction of the luminance intra prediction mode. Also, an arrangement may be made in which two such intra prediction modes adjacent to the prediction direction of the luminance intra prediction mode are defined as the adjacent modes. In this case, the total number of color difference determination information is increased by 1. However, as a tradeoff advantage, another mode, which is assumed to have a high probability of occurrence, can be employed as an additional color difference intra prediction mode candidate. With such an arrangement, a prediction mode can be represented by only the adjacent modes when there is a small difference in the prediction direction between the luminance intra prediction mode and the color difference intra prediction mode. Thus, by defining, as the horizontal/vertical mode, a mode from among the horizontal mode and the vertical mode having a larger angle between itself and the luminance intra prediction mode, such an arrangement is capable of avoiding a situation in which coding efficiency is greatly reduced even if there is a low correlation between the luminance intra prediction mode and the color difference intra prediction mode.

The image encoding apparatus and the image decoding apparatus described above provides the following functions and effects.

(1) In the encoding of the color difference intra prediction mode encoding, the mode having the same value as that of the luminance intra prediction mode is preferentially transmitted, thereby reducing the average generated code quantity, and thereby providing improved coding efficiency.

(2) The horizontal/vertical mode, which represents one mode selected from among the horizontal mode and the vertical mode, is defined. The color difference intra prediction mode occurs with a low probability when there is a great difference in the prediction direction between the luminance intra prediction mode and the color difference intra prediction mode, compared to when there is a small difference in the prediction direction between the luminance intra prediction mode and the color difference intra prediction mode. In a case in which both the horizontal mode and the vertical mode are to be defined as independent respective modes, such an arrangement leads to an increase in the total number of modes, and leads to an increase in the average generated code quantity. In order to solve such a problem, by eliminating the mode that occurs with a lower probability of occurrence from the code calculation, such an arrangement reduces the average generated code quantity.

(3) The color difference intra prediction mode having a prediction direction adjacent to the luminance intra prediction mode is defined. Such an adjacent mode occurs with a high probability, thereby reducing the average generated code quantity.

The encoded stream of a moving image output from the moving image encoding apparatus according to the aforementioned embodiment has a predetermined data format which can be decoded using the decoding method according to the embodiment. Thus, the moving image decoding apparatus that corresponds to the moving image encoding apparatus is capable of decoding the encoded stream having such a predetermined data format.

In a case in which a wired or wireless network is used to allow such an encoded stream to be transmitted/received between the moving image encoding apparatus and the moving image decoding apparatus, such an encoded stream may be converted into encoded data having a data format suitable for the manner of transmission employed for the transmission path thus employed. In this case, such an arrangement further includes: a moving image transmitting apparatus configured to convert the encoded stream output from the moving image encoding apparatus into encoded data having a data format suitable for the manner of transmission employed for the transmission path, and to transmit the encoded data thus converted to a network; and a moving image receiving apparatus configured to receive the encoded data from the network, to reconstruct the encoded data as the encoded stream, and to supply the encoded stream thus restored to the moving image decoding apparatus.

The moving image transmitting apparatus includes: memory configured as a buffer which stores an encoded stream output from the moving image encoding apparatus; a packet processing unit configured to convert the encoded stream into packets; and a transmitting unit configured to transmit the encoded data in the form of packets via a network. The moving image receiving apparatus includes a receiving unit configured to receive the encoded data in the form of packets via the network; memory configured as a buffer which stores the encoded data thus received; and a packet processing unit configured to perform packet processing on the encoded data thus received so as to generate an encoded stream, and to supply the encoded stream thus generated to the moving image decoding apparatus.

It is needless to say that the aforementioned operations for encoding and decoding can be realized as a transmitting apparatus, a storage apparatus, and a receiving apparatus, by means of hardware components. Also, such operations can be realized by means of software components such as firmware stored in ROM (Read Only Memory), flash memory, or the like, or otherwise a software program loaded on a computer or the like. Such firmware or a software program may be provided as a computer-readable recording medium storing such firmware or a software program. Also, such firmware or a software program may be provided by a server via a wired or otherwise wireless network, or via data broadcasting such as terrestrial digital broadcasting or satellite digital broadcasting.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

What is claimed is:

1. An image encoding apparatus configured to encode an image signal in units of blocks using an intra frame prediction mode selected from among a plurality of intra frame prediction modes, and to encode information to be used to identify the intra frame prediction mode thus selected, the image encoding apparatus comprising:
a luminance component intra frame prediction mode encoding unit configured to encode an intra frame prediction mode for a luminance component of an encoding target block;
a luminance component intra frame prediction mode storage unit configured to store the intra frame prediction mode for the luminance component of the encoding target block; and
a color difference component intra frame prediction mode encoding unit configured to encode color difference prediction mode determination information used to identify the intra frame prediction mode for a color difference component of the encoding target block with reference to the intra frame prediction mode for the luminance component of the encoding target block stored in the luminance component intra frame prediction mode storage unit,
wherein, when the intra frame prediction mode for the color difference component of the encoding target block is the same as the intra frame prediction mode for the luminance component of the encoding target block, the color difference component intra frame prediction mode encoding unit is configured to encode the color difference prediction mode determination information which represents an inheritance mode in which the intra frame prediction mode for the luminance component is used as it is as the intra frame prediction mode for the color difference component of the encoding target block,
and wherein the color difference component intra frame prediction mode encoding unit is configured to encode the color difference prediction mode determination information which represents a vertical/horizontal mode in which a mode having a smaller angle or otherwise a greater angle between itself and the intra frame prediction mode for the luminance component of the encoding target block is selected from among a vertical mode and a horizontal mode, which are each configured as an intra frame prediction mode for the color difference component, as an intra frame prediction mode for the color difference component of the encoding target block.

2. An image encoding apparatus configured to encode an image signal in units of blocks using an intra frame prediction mode selected from among a plurality of intra frame prediction modes, and to encode information to be used to identify the intra frame prediction mode thus selected, the image encoding apparatus comprising:
a luminance component intra frame prediction mode encoding unit configured to encode an intra frame prediction mode for a luminance component of an encoding target block;
a luminance component intra frame prediction mode storage unit configured to store the intra frame prediction mode for the luminance component of the encoding target block; and
a color difference component intra frame prediction mode encoding unit configured to encode color difference prediction mode determination information used to identify the intra frame prediction mode for a color difference component of the encoding target block with reference to the intra frame prediction mode for the luminance component of the encoding target block stored in the luminance component intra frame prediction mode storage unit,
wherein, when the intra frame prediction mode for the color difference component of the encoding target block is the same as the intra frame prediction mode for the luminance component of the encoding target block, the color difference component intra frame prediction mode encoding unit is configured to encode the color difference prediction mode determination information which represents an inheritance mode in which the intra frame prediction mode for the luminance component is used as it is as the intra frame prediction mode for the color difference component of the encoding target block,
and wherein the color difference component intra frame prediction mode encoding unit is configured to encode the color difference prediction mode determination information which represents an adjacent mode in which a mode adjacent to the intra frame prediction mode for the luminance component of the encoding target block is selected from among a plurality of intra frame prediction modes for the color difference component as an intra frame prediction mode for the color difference component of the encoding target block.

3. An image encoding method for encoding an image signal in units of blocks using an intra frame prediction mode selected from among a plurality of intra frame prediction modes, and for encoding information to be used to identify the intra frame prediction mode thus selected, the image encoding method comprising:
luminance component intra frame prediction mode encoding in which an intra frame prediction mode for a luminance component of an encoding target block is encoded; and
color difference component intra frame prediction mode encoding in which color difference component intra frame prediction mode determination information used to identify the intra frame prediction mode for a color difference component of the encoding target block is encoded with reference to the intra frame prediction mode for the luminance component of the encoding target block stored in memory configured to store the intra frame prediction mode for the luminance component of the encoding target block,
wherein, in the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded,
and wherein, in the aforementioned color difference component intra frame prediction mode encoding, the color difference prediction mode determination information which represents a vertical/horizontal mode in which a mode having a smaller angle or otherwise a greater angle between itself and the intra frame prediction mode for the luminance component of the encoding target block is selected from among a vertical mode and a horizontal mode, which are each configured as an intra frame prediction mode for the color difference component, as an intra frame prediction mode for the color difference component of the encoding target block, is encoded.

4. An image encoding method for encoding an image signal in units of blocks using an intra frame prediction mode selected from among a plurality of intra frame prediction modes, and for encoding information to be used to identify the intra frame prediction mode thus selected, the image encoding method comprising:
luminance component intra frame prediction mode encoding in which an intra frame prediction mode for a luminance component of an encoding target block is encoded; and
color difference component intra frame prediction mode encoding in which color difference component intra frame prediction mode determination information used to identify the intra frame prediction mode for a color difference component of the encoding target block is encoded with reference to the intra frame prediction mode for the luminance component of the encoding target block stored in memory configured to store the intra frame prediction mode for the luminance component of the encoding target block,
wherein, in the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded,
and wherein, in the aforementioned color difference component intra frame prediction mode encoding, the color difference prediction mode determination information which represents an adjacent mode in which a mode adjacent to the intra frame prediction mode for the luminance component of the encoding target block is selected from among a plurality of intra frame prediction modes for the color difference component as an intra frame prediction mode for the color difference component of the encoding target block, is encoded.

5. An image encoding computer program configured to instruct a computer to encode an image signal in units of blocks using an intra frame prediction mode selected from among a plurality of intra frame prediction modes, and to encode information to be used to identify the intra frame prediction mode thus selected, the image encoding computer program comprising:
a luminance component intra frame prediction mode encoding module configured to instruct the computer to encode an intra frame prediction mode for a luminance component of an encoding target block; and
a color difference component intra frame prediction mode encoding module configured to instruct the computer to encode color difference prediction mode determination information used to identify the intra frame prediction mode for a color difference component of the encoding target block with reference to the intra frame prediction mode for the luminance component of the encoding target block stored in memory configured to store the intra frame prediction mode for the luminance component of the encoding target block,
wherein, in the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded,
and wherein, in the aforementioned color difference component intra frame prediction mode encoding, the color difference prediction mode determination information which represents a vertical/horizontal mode in which a mode having a smaller angle or otherwise a greater angle between itself and the intra frame prediction mode for the luminance component of the encoding target block is selected from among a vertical mode and a horizontal mode, which are each configured as an intra frame prediction mode for the color difference component, as an intra frame prediction mode for the color difference component of the encoding target block, is encoded.

6. An image encoding computer program configured to instruct a computer to encode an image signal in units of blocks using an intra frame prediction mode selected from among a plurality of intra frame prediction modes, and to encode information to be used to identify the intra frame prediction mode thus selected, the image encoding computer program comprising:
a luminance component intra frame prediction mode encoding module configured to instruct the computer to encode an intra frame prediction mode for a luminance component of an encoding target block; and
a color difference component intra frame prediction mode encoding module configured to instruct the computer to encode color difference prediction mode determination information used to identify the intra frame prediction mode for a color difference component of the encoding target block with reference to the intra frame prediction mode for the luminance component of the encoding target block stored in memory configured to store the intra frame prediction mode for the luminance component of the encoding target block,
wherein, in the aforementioned color difference component intra frame prediction mode encoding, when the intra frame prediction mode for the color difference component of the encoding target block is the same as the intra frame prediction mode for the luminance component of the encoding target block, the color difference prediction mode determination information which represents an inheritance mode in which the intra frame prediction mode for the luminance component is used as it is as the intra frame prediction mode for the color difference component of the encoding target block, is encoded,
and wherein, in the aforementioned color difference component intra frame prediction mode encoding, the color difference prediction mode determination information which represents an adjacent mode in which a mode adjacent to the intra frame prediction mode for the luminance component of the encoding target block is selected from among a plurality of intra frame prediction modes for the color difference component as an intra frame prediction mode for the color difference component of the encoding target block, is encoded.

7. An image decoding apparatus configured to decode an encoded stream into information to be used to identify an intra frame prediction mode in units of blocks, and to decode an image signal using the decoded information for identifying the intra frame prediction mode, the image decoding apparatus comprising:
a luminance component intra frame prediction mode decoding unit configured to decode an intra frame prediction mode for a luminance component of a decoding target block;
a luminance component intra frame prediction mode storage unit configured to store the intra frame prediction mode for the luminance component of the decoding target block; and
a color difference component intra frame prediction mode decoding unit configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in the luminance component intra frame prediction mode storage unit,
wherein, when the color difference prediction mode determination information thus decoded indicates an inheritance mode in which the intra frame prediction mode for the luminance component of the decoding target block is to be used as it is as the intra frame prediction mode for the color difference component of the decoding target block, the color difference component intra frame prediction mode decoding unit is configured to set the intra frame prediction mode for the color difference component of the decoding target block to the same value as that of the intra frame prediction mode for the luminance component of the decoding target block,
and wherein, when the color difference prediction mode determination information thus decoded indicates a vertical/horizontal mode in which either a vertical mode or a horizontal mode, which are each configured as an intra frame prediction mode for the color difference component, is selectively used, the color difference component intra frame prediction mode decoding unit is configured to set the color difference component intra frame prediction mode for the decoding target block to a mode selected from among the vertical mode and the horizontal mode, which are each configured as a color difference component intra frame prediction mode, such that it has a smaller or otherwise greater angle between itself and the intra frame prediction mode for the luminance component of the decoding target block.

8. An image decoding apparatus configured to decode an encoded stream into information to be used to identify an intra frame prediction mode in units of blocks, and to decode an image signal using the decoded information for identifying the intra frame prediction mode, the image decoding apparatus comprising:
a luminance component intra frame prediction mode decoding unit configured to decode an intra frame prediction mode for a luminance component of a decoding target block;
a luminance component intra frame prediction mode storage unit configured to store the intra frame prediction mode for the luminance component of the decoding target block; and
a color difference component intra frame prediction mode decoding unit configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in the luminance component intra frame prediction mode storage unit,
wherein, when the color difference prediction mode determination information thus decoded indicates an inheritance mode in which the intra frame prediction mode for the luminance component of the decoding target block is to be used as it is as the intra frame prediction mode for the color difference component of the decoding target block, the color difference component intra frame prediction mode decoding unit is configured to set the intra frame prediction mode for the color difference component of the decoding target block to the same value as that of the intra frame prediction mode for the luminance component of the decoding target block,
and wherein, when the color difference prediction mode determination information thus decoded indicates an adjacent mode in which a mode adjacent to the intra frame prediction mode for the luminance component of the decoding target block is used, the color difference component intra frame prediction mode decoding unit is configured to set the intra frame prediction mode for the color difference component of the decoding target block to a mode adjacent to the intra frame prediction mode for the luminance component of the decoding target block selected from among a plurality of intra frame prediction modes for the color difference component.

9. An image decoding method for decoding an encoded stream into information to be used to identify an intra frame prediction mode in units of blocks, and for decoding an image signal using the decoded information for identifying the intra frame prediction mode, the image decoding method comprising:
luminance component intra frame prediction mode decoding in which an intra frame prediction mode for a luminance component of a decoding target block is decoded; and
color difference component intra frame prediction mode decoding in which color difference prediction mode determination information to be used to identify an intra frame prediction mode for a color difference component of the decoding target block is decoded, and the intra frame prediction mode for the color difference component of the decoding target block is obtained based upon the color difference prediction mode determination information with reference to the intra frame prediction mode for the luminance component of the decoding target block stored in memory configured to store the intra frame prediction mode for the luminance component of the decoding target block,
wherein, in the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block,
and wherein, in the color difference component intra frame prediction mode decoding, when the color difference prediction mode determination information thus decoded indicates a vertical/horizontal mode in which either a vertical mode or a horizontal mode, which are each configured as an intra frame prediction mode for the color difference component, is selectively used, the color difference component intra frame prediction mode for the decoding target block is set to a mode selected from among the vertical mode and the horizontal mode, which are each configured as a color difference component intra frame prediction mode, such that it has a smaller or otherwise greater angle between itself and the intra frame prediction mode for the luminance component of the decoding target block.

10. An image decoding method for decoding an encoded stream into information to be used to identify an intra frame prediction mode in units of blocks, and for decoding an image signal using the decoded information for identifying the intra frame prediction mode, the image decoding method comprising:
luminance component intra frame prediction mode decoding in which an intra frame prediction mode for a luminance component of a decoding target block is decoded; and
color difference component intra frame prediction mode decoding in which color difference prediction mode determination information to be used to identify an intra frame prediction mode for a color difference component of the decoding target block is decoded, and the intra frame prediction mode for the color difference component of the decoding target block is obtained based upon the color difference prediction mode determination information with reference to the intra frame prediction mode for the luminance component of the decoding target block stored in memory configured to store the intra frame prediction mode for the luminance component of the decoding target block,
wherein, in the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block,
and wherein, in the color difference component intra frame prediction mode decoding, when the color difference prediction mode determination information thus decoded indicates an adjacent mode in which a mode adjacent to the intra frame prediction mode for the luminance component of the decoding target block is used, the intra frame prediction mode for the color difference component of the decoding target block is set to a mode adjacent to the intra frame prediction mode for the luminance component of the decoding target block selected from among a plurality of intra frame prediction modes for the color difference component.

11. An image decoding computer program configured to instruct a computer to decode an encoded stream into information to be used to identify an intra frame prediction mode in units of blocks, and to decode an image signal using the decoded information for identifying the intra frame prediction mode, the image decoding computer program comprising:
luminance component intra frame prediction mode decoding module configured to decode an intra frame prediction mode for a luminance component of a decoding target block; and
color difference component intra frame prediction mode decoding module configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in memory configured to store the intra frame prediction mode for the luminance component of the decoding target block,
wherein, in the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block,
and wherein, in the color difference component intra frame prediction mode decoding, when the color difference prediction mode determination information thus decoded indicates a vertical/horizontal mode in which either a vertical mode or a horizontal mode, which are each configured as an intra frame prediction mode for the color difference component, is selectively used, the color difference component intra frame prediction mode for the decoding target block is set to a mode selected from among the vertical mode and the horizontal mode, which are each configured as a color difference component intra frame prediction mode, such that it has a smaller or otherwise greater angle between itself and the intra frame prediction mode for the luminance component of the decoding target block.

12. An image decoding computer program configured to instruct a computer to decode an encoded stream into information to be used to identify an intra frame prediction mode in units of blocks, and to decode an image signal using the decoded information for identifying the intra frame prediction mode, the image decoding computer program comprising:
luminance component intra frame prediction mode decoding module configured to decode an intra frame prediction mode for a luminance component of a decoding target block; and
color difference component intra frame prediction mode decoding module configured to decode color difference prediction mode determination information to be used to identify an intra frame prediction mode for a color difference component of the decoding target block, and to obtain the intra frame prediction mode for the color difference component of the decoding target block based upon the color difference prediction mode determination information with reference to the intra frame prediction mode for the luminance component of the decoding target block stored in memory configured to store the intra frame prediction mode for the luminance component of the decoding target block,
wherein, in the color difference component intra frame prediction mode decoding, when the color difference prediction mode determination information thus decoded indicates an inheritance mode in which the intra frame prediction mode for the luminance component of the decoding target block is to be used as it is as the intra frame prediction mode for the color difference component of the decoding target block, the intra frame prediction mode for the color difference component of the decoding target block is set to the same value as that of the intra frame prediction mode for the luminance component of the decoding target block,
and wherein, in the color difference component intra frame prediction mode decoding, when the color difference prediction mode determination information thus decoded indicates an adjacent mode in which a mode adjacent to the intra frame prediction mode for the luminance component of the decoding target block is used, the intra frame prediction mode for the color difference component of the decoding target block is set to a mode adjacent to the intra frame prediction mode for the luminance component of the decoding target block selected from among a plurality of intra frame prediction modes for the color difference component.
